(19) United States
(12) Patent Application Publication
(10) Pub. No.: US 2025/0249830 A1
(43) Pub. Date: Aug. 7, 2025

(54) BRAKING SYSTEM FOR A MILITARY VEHICLE

(71) Applicant: Oshkosh Corporation, Oshkosh, WI (US)

(72) Inventors: Kevin Dwyer, Oshkosh, WI (US); Isaiah Kronebusch, Oshkosh, WI (US); Steven Carstens, Oshkosh, WI (US); Ethan Ensign, Oshkosh, WI (US); Joshua Murman, Oshkosh, WI (US); James Doering, Oshkosh, WI (US); Ben Wellens, Oshkosh, WI (US); Luke Gustafson, Oshkosh, WI (US); Geoffrey R. Bossio, Beverly Hills, MI (US); Michael J. Mitchell, Plymouth, MI (US)

(73) Assignee: Oshkosh Corporation, Oshkosh, WI (US)

(21) Appl. No.: 19/187,870

(22) Filed: Apr. 23, 2025

Related U.S. Application Data
(63) Continuation of application No. 17/698,423, filed on Mar. 18, 2022, now abandoned.

(51) Int. Cl. B60Q 9/00; B60K 35/00; B60K 35/10; B60K 35/22; B60K 35/28; B60Q 5/00; B60T 17/22

(52) U.S. Cl. CPC B60Q 9/00; B60K 35/00; B60Q 5/005; B60T 17/22; B60K 35/10; B60K 35/22; B60K 35/28; B60K 2360/178; B60T 2210/20; B60T 2250/00; B60T 2250/02; B60T 2270/406; B60T 2270/88

(57) ABSTRACT

A control system for a military vehicle includes processing circuitry configured to obtain a weight, an incline, a brake air supply pressure, a current gear, and a transaxle range of the military vehicle. The processing circuitry is also configured to determine a minimum brake air supply pressure for the military vehicle based on the weight, the incline, the current gear, and the transaxle range of the military vehicle. The processing circuitry is also configured to compare the brake air supply pressure to the minimum brake air supply pressure, and, in response to the brake air supply pressure being less than the minimum brake air supply pressure, operate a display of the military vehicle to provide an alarm to an operator of the military vehicle to notify the operator that the brake air supply pressure is less than the minimum brake air supply pressure.

### CROSS-REFERENCE TO RELATED PATENT APPLICATION

This application is a continuation of U.S. application Ser. No. 17/698,423, filed Mar. 18, 2022, the entire disclosure of which is incorporated by reference herein.

### STATEMENT REGARDING FEDERALLY-SPONSORED RESEARCH OR DEVELOPMENT

This invention was made with government support under contract W56HZV-15-C-0095, STS Work Directive 0095-104, titled “Brake System Enhancement,” awarded by the Department of Defense. The government has certain rights in the invention.

### BACKGROUND

The present application relates to vehicles. In particular, the present application relates to the structural frame assembly of a military vehicle.

A military vehicle may be used in a variety of applications and conditions. These vehicles generally include a number of vehicle systems or components (e.g., a cab or body, a drive train, etc.). The military vehicle may also include various features and systems as needed for the specific application of the vehicle (e.g., a hatch, a gun ring, an antenna, etc.). Proper functioning and arrangement of the vehicle systems or components is important for the proper functioning of the vehicle.

Traditional military vehicles include a cab assembly coupled to a pair of frame rails that extend along the length of the vehicle. The drive train, engine, and other components of the vehicle are coupled to the frame rails. Such vehicles may be transported by securing lifting slings to the frame rails and applying a lifting force (e.g., with a crane, with a helicopter, etc.). As the frame rails are the primary structure of the vehicle, a lifting force applied to a rear portion and a front portion elevate the vehicle from a ground surface. In such a configuration, the components of the vehicle must be coupled to the structural frame rails thereby requiring sequential assembly.

### SUMMARY

One embodiment of the present disclosure is a control system for a military vehicle. The control system includes processing circuitry. The processing circuitry is configured to obtain a weight, an incline, a brake air supply pressure, a current gear, and a transaxle range of the military vehicle. The processing circuitry is also configured to determine a minimum brake air supply pressure for the military vehicle based on the weight, the incline, the current gear, and the transaxle range of the military vehicle. The processing circuitry is also configured to compare the brake air supply pressure to the minimum brake air supply pressure, and, in response to the brake air supply pressure being less than the minimum brake air supply pressure, operate a display of the military vehicle to provide an alarm to an operator of the military vehicle to notify the operator that the brake air supply pressure is less than the minimum brake air supply pressure.

In some embodiments, determining the minimum brake air supply pressure includes selecting a relationship or a table from a plurality of relationships or tables based on (i) a sign of the incline, (ii) whether the current gear is a forwards or a reverse gear, and (iii) whether the transaxle range is high or low. In some embodiments, determining the minimum brake air supply pressure further includes using (i) an absolute value of the incline and (ii) the weight of the military vehicle as inputs to the relationship or table to determine the minimum brake air supply pressure.

In some embodiments, the plurality of relationships or tables include eight relationships or tables. In some embodiments, each of the eight relationships or tables correspond to a particular combination of (i) the sign of the incline, (ii) whether the current gear is a forwards or a reverse gear, and (iii) whether the transaxle range is high or low.

In some embodiments, the minimum brake air supply pressure is a trigger value to prompt the alarm to notify the operator that the military vehicle should be brought to a complete stop to allow a brake system of the military vehicle to re-pressurize. In some embodiments, processing circuitry is configured to operate the display of the military vehicle to cease providing the alarm in response to the brake air supply pressure exceeding the minimum brake air supply pressure by at least a predetermined amount.

In some embodiments, obtaining the brake air supply pressure includes obtaining a primary brake air pressure and a secondary brake air pressure, and determining an average of the primary brake air pressure and the secondary brake air pressure as the brake air supply pressure. In some embodiments, the processing circuitry is configured to receive a user command to dismiss the alarm, and mute an aural alert of the alarm in response to receiving the user command to dismiss the alarm.

In some embodiments, the processing circuitry is further configured to receive a user command to disable the alarm. In some embodiments, the processing circuitry is configured to present a confirmation screen to the operator in response to receiving the user command to disable the alarm, and in response to receiving a confirmation from the operator to disable the alarm, disabling the alarm and limiting further alarm functionality until power of the military vehicle is cycled.

In some embodiments, the processing circuitry is configured to obtain the weight of the military vehicle from a suspension system of the military vehicle, the incline from the suspension system of the military vehicle, the brake air supply pressure from an instrument panel of the military vehicle, the current gear from a transmission of the military vehicle, and the transaxle range from a transaxle of the military vehicle.

In some embodiments, the control system is operable between an enabled state, an alarm active state, an alarm dismissed state, and an alarm disabled state. In some embodiments, in the enabled state, the processing circuitry continually determines the minimum brake air supply pressure, and compares the brake air supply pressure to the minimum brake air supply pressure, and does not provide the alarm to the operator. In some embodiments, in the alarm active state, the processing circuitry operates the display of the military vehicle to provide the alarm including an aural alert. In some embodiments, in the alarm dismissed state, the processing circuitry mutes the aural alert of the alarm. In some embodiments, in the alarm disabled state, the processing circuitry does not provide the alarm, restricts additional alarm functionality of the control system, and provides a visual alert that the control system is in the alarm disabled state.

In some embodiments, the processing circuitry is configured to initially transition the control system into the enabled state in response to obtaining the weight, the incline, the brake air supply pressure, the current gear, and the transaxle, and determining the minimum brake air supply pressure. In some embodiments, the processing circuitry is configured to transition the control system out of the enabled state and into the alarm active state in response to the brake air supply pressure being less than the minimum brake air supply pressure. In some embodiments, the processing circuitry is configured to transition the control system out of the alarm active state and into the alarm dismissed state in response to receiving a command from the operator to dismiss the alarm. In some embodiments, the processing circuitry is configured to transition the control system out of the alarm dismissed state and into the alarm disabled state in response to receiving a command from the operator to disabled the alarm, and in response to confirmation from the operator to transition into the alarm disabled state. In some embodiments, the processing circuitry is configured to transition the control system out of the alarm dismissed state or the alarm active state and into the enabled state in response to the brake air supply pressure exceeding the minimum brake air supply pressure by a predetermined amount.

Another embodiment of the present disclosure is a control system for a military vehicle. The control system includes processing circuitry configured to obtain a weight, an incline, a brake air supply pressure, a current gear, and a transaxle range of the military vehicle, according to some embodiments. In some embodiments, the processing circuitry is configured to determine a minimum brake air supply pressure for the military vehicle based on the weight, the incline, the current gear, and the transaxle range of the military vehicle. In some embodiments, the processing circuitry is configured to compare the brake air supply pressure to the minimum brake air supply pressure, and, in response to the brake air supply pressure being less than the minimum brake air supply pressure, operate a display of the military vehicle to provide an alarm to an operator of the military vehicle to notify the operator that the brake air supply pressure is less than the minimum brake air supply pressure. In some embodiments, the control system is operable between an enabled state, an alarm active state, an alarm dismissed state, and an alarm disabled state. In some embodiments, in the enabled state, the processing circuitry continually determines the minimum brake air supply pressure, and compares the brake air supply pressure to the minimum brake air supply pressure, and does not provide the alarm to the operator. In some embodiments, in the alarm active state, the processing circuitry operates the display of the military vehicle to provide the alarm including an aural alert. In some embodiments, in the alarm dismissed state, the processing circuitry mutes the aural alert of the alarm. In some embodiments, in the alarm disabled state, the processing circuitry does not provide the alarm, restricts additional alarm functionality of the control system, and provides a visual alert that the control system is in the alarm disabled state.

In some embodiments, the processing circuitry is configured to initially transition the control system into the enabled state in response to obtaining the weight, the incline, the brake air supply pressure, the current gear, and the transaxle, and determining the minimum brake air supply pressure. In some embodiments, the processing circuitry is configured to transition the control system out of the enabled state and into the alarm active state in response to the brake air supply pressure being less than the minimum brake air supply pressure. In some embodiments, the processing circuitry is configured to transition the control system out of the alarm active state and into the alarm dismissed state in response to receiving a command from the operator to dismiss the alarm. In some embodiments, the processing circuitry is configured to transition the control system out of the alarm dismissed state and into the alarm disabled state in response to receiving a command from the operator to disabled the alarm, and in response to confirmation from the operator to transition into the alarm disabled state. In some embodiments, the processing circuitry is configured to transition the control system out of the alarm dismissed state or the alarm active state and into the enabled state in response to the brake air supply pressure exceeding the minimum brake air supply pressure by a predetermined amount.

In some embodiments, determining the minimum brake air supply pressure includes selecting a relationship or a table from a plurality of relationships or tables based on (i) a sign of the incline, (ii) whether the current gear is a forwards or a reverse gear, and (iii) whether the transaxle range is high or low. In some embodiments, determining the minimum brake air supply pressure further includes using (i) an absolute value of the incline and (ii) the weight of the military vehicle as inputs to the relationship or table to determine the minimum brake air supply pressure.

In some embodiments, the plurality of relationships or tables include eight relationships or tables. In some embodiments, each of the eight relationships or tables correspond to a particular combination of (i) the sign of the incline, (ii) whether the current gear is a forwards or a reverse gear, and (iii) whether the transaxle range is high or low.

In some embodiments, the minimum brake air supply pressure is a trigger value to prompt the alarm to notify the operator that the military vehicle should be brought to a complete stop to allow a brake system of the military vehicle to re-pressurize.

In some embodiments, obtaining the brake air supply pressure includes obtaining a primary brake air pressure and a secondary brake air pressure, and determining an average of the primary brake air pressure and the secondary brake air pressure as the brake air supply pressure.

In some embodiments, the processing circuitry is configured to obtain the weight of the military vehicle from a suspension system of the military vehicle, the incline from the suspension system of the military vehicle, the brake air supply pressure from an instrument panel of the military vehicle, the current gear from a transmission of the military vehicle, and the transaxle range from a transaxle of the military vehicle.

Another embodiment of the present disclosure is a control system for a military vehicle. The control system includes processing circuitry. The processing circuitry is configured to obtain a weight, an incline, a brake air supply pressure, a current gear, and a transaxle range of the military vehicle. The processing circuitry is also configured to determine a minimum brake air supply pressure for the military vehicle based on the weight, the incline, the current gear, and the transaxle range of the military vehicle. The processing circuitry is also configured to compare the brake air supply pressure to the minimum brake air supply pressure, and, in response to the brake air supply pressure being less than the minimum brake air supply pressure, operate a display of the military vehicle to provide an alarm to an operator of the military vehicle to notify the operator that the brake air supply pressure is less than the minimum brake air supply pressure. In some embodiments, determining the minimum brake air supply pressure includes selecting a relationship or a table from a plurality of relationships or tables based on (i) a sign of the incline, (ii) whether the current gear is a forwards or a reverse gear, and (iii) whether the transaxle range is high or low. In some embodiments, determining the minimum brake air supply pressure further includes using (i) an absolute value of the incline and (ii) the weight of the military vehicle as inputs to the relationship or table to determine the minimum brake air supply pressure.

In some embodiments, the plurality of relationships or tables include eight relationships or tables. In some embodiments, each of the eight relationships or tables correspond to a particular combination of (i) the sign of the incline, (ii) whether the current gear is a forwards or a reverse gear, and (iii) whether the transaxle range is high or low.

The invention is capable of other embodiments and of being carried out in various ways. Alternative exemplary embodiments relate to other features and combinations of features as may be recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIGS. 1-2 are a perspective views of a vehicle, according to an exemplary embodiment.

FIG. 3 is a schematic side view of the vehicle of FIG. 1, according to an exemplary embodiment.

FIGS. 4-6 are perspective views of a vehicle having a passenger capsule, a front module, and a rear module, according to an exemplary embodiment.

FIGS. 7-9 are perspective views of a vehicle having a passenger capsule, a front module, and a rear module, according to an alternative embodiment.

FIG. 10A is a schematic sectional view of a vehicle having at least a portion of a suspension system coupled to a transaxle, according to an exemplary embodiment, and FIG. 10B is schematic sectional view of a vehicle having a passenger capsule, according to an exemplary embodiment.

FIG. 11 is schematic view of a braking system for a vehicle, according to an exemplary embodiment.

FIG. 12 is schematic view of a vehicle control system, according to an exemplary embodiment.

FIG. 13 is a diagram of a brake warning system of the vehicle of FIG. 1, according to an exemplary embodiment.

FIG. 14 is a diagram of a process for providing alarms regarding a pressure of brakes of the vehicle of FIG. 1, according to an exemplary embodiment.

FIG. 15 is a state diagram showing different states of the brake warning system of FIG. 13, according to an exemplary embodiment.

FIG. 16 is a flow diagram of a process for actuating an alarm to notify an operator regarding low air pressure of the brakes of the vehicle of FIG. 1, according to an exemplary embodiment.

FIG. 17 is a diagram of a process for operating a display screen of the vehicle of FIG. 1 to provide alarms or to dismiss or disable the brake warning system of FIG. 13, according to an exemplary embodiment.

FIG. 18 is a diagram showing a process for dismissing alarms and disabling the brake warning system of FIG. 13, according to an exemplary embodiment.

FIG. 19 is a user interface showing a confirmation screen that may be presented to an operator of the vehicle of FIG. 1 when the operator requests to disable the brake warning system of FIG. 13, according to an exemplary embodiment.

FIG. 20 is a user interface illustrating presentation of a brake alarm and a brake alarm disable, according to an exemplary embodiment.

FIG. 21A is a side view of the vehicle of FIG. 1 travelling on an upwards or positive grade or incline, according to an exemplary embodiment.

FIG. 21B is a side view of the vehicle of FIG. 1 travelling on a downwards or negative grade of incline, according to an exemplary embodiment.

FIG. 22 is a flow diagram of a process for providing an alarm in response to braking conditions for the military vehicle of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the FIGURES, a braking alarm system can monitor various conditions of a military vehicle, and alert or alarm an operator of the military vehicle when current braking air supply pressure is insufficient. The braking alarm system can include processing circuitry that obtains a weight of the military vehicle, a current brake air supply pressure, a current incline or grade of a surface upon which the military vehicle rests or is travelling, a current or selected gear of a transmission of the military vehicle, and a current range (e.g., high or low) of a transaxle of the military vehicle. The processing circuitry may use the current gear (e.g., whether the current gear is a forwards or reverse gear), a sign of the incline (e.g., positive such as going uphill, or negative such as going downhill), and the range of the transaxle (e.g., high or low) to select a relationship or table. The processing circuitry may use an absolute value of the current incline and the weight of the military vehicle as inputs to the relationship or table to determine a minimum brake air supply pressure that is required for stopping the military vehicle (e.g., to fully stop the military vehicle given current conditions). The processing circuitry can compare the current brake air supply pressure to the minimum brake air supply pressure to determine if the current brake air supply pressure is sufficient (e.g., greater than or equal to the minimum brake air supply pressure). If the current brake air supply pressure is less than the minimum brake air supply pressure, the processing circuitry may operate a display screen or display unit of the military vehicle to provide at least one of a visual or aural alert to the operator. The processing circuitry may also receive commands to dismiss or disable the visual or aural alerts.

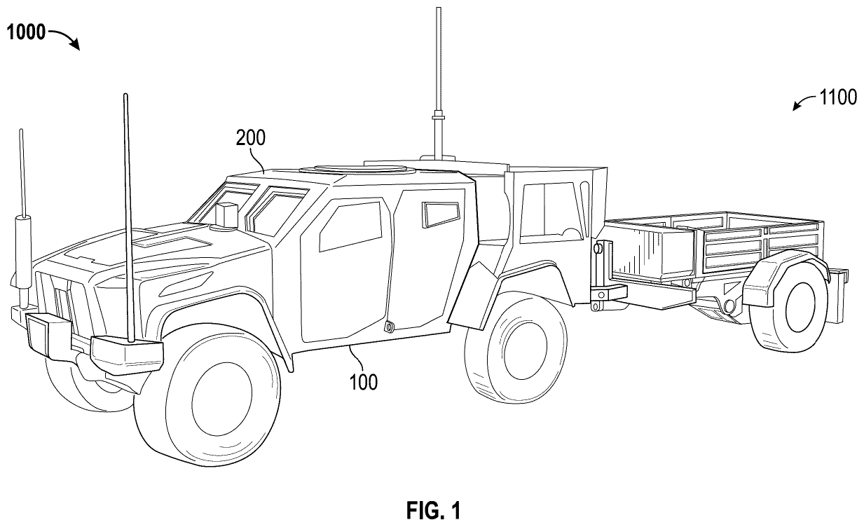

Referring to FIGS. 1-3, a military vehicle 1000 includes a hull and frame assembly 100, an armor assembly 200, an engine 300, a transmission 400, a transaxle 450, wheel and tire assemblies 600, a braking system 700, a fuel system 800, and a suspension system 460 coupling the hull and frame assembly 100 to the wheel and tire assemblies 600. According to an exemplary embodiment, the military vehicle 1000 includes a power generation system 900. As shown in FIG. 1, the military vehicle 1000 also includes a trailer 1100.

### Hull and Frame Assembly

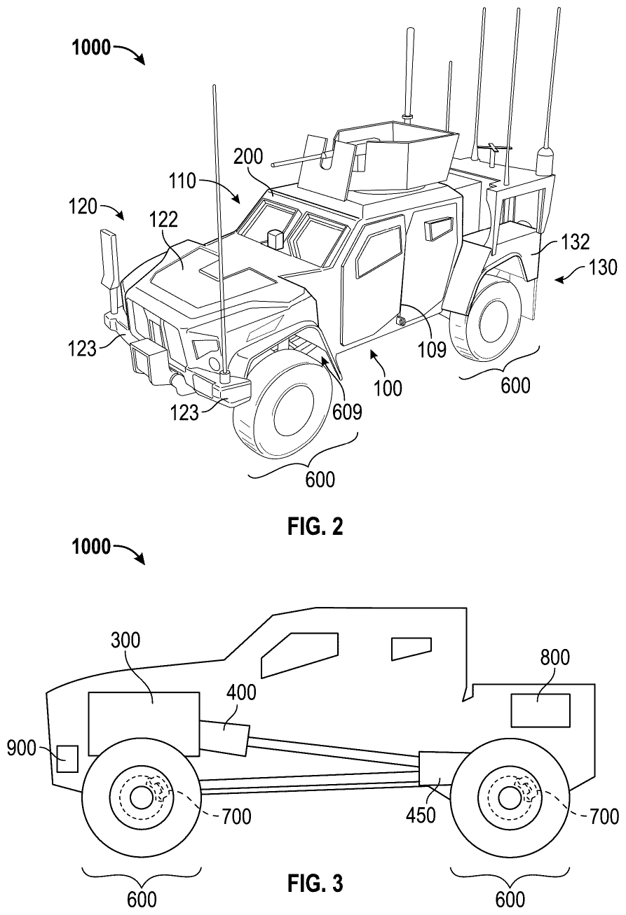

Referring to FIG. 2, the hull and frame assembly 100 includes a passenger capsule, shown as passenger capsule 110, a front module, shown as front module 120, and a rear module, shown as rear module 130. According to an exemplary embodiment, the front module 120 and the rear module 130 are coupled to the passenger capsule 110 with a plurality of interfaces. As shown in FIG. 2, the front module 120 includes a front axle having wheel and tire assemblies 600.

According to an exemplary embodiment, the rear module 130 includes a body assembly, shown as bed 132. As shown in FIG. 2, front module 120 also includes a body panel, shown as hood 122. In some embodiments, the hood 122 partially surrounds the engine of military vehicle 1000. The hood 122 is constructed of a composite material (e.g., carbon fiber, fiberglass, a combination of fiberglass and carbon fiber, etc.) and sculpted to maximize vision and clear under-hood components. According to an alternative embodiment, the hood 122 is manufactured from another material (e.g., steel, aluminum, etc.). The front portion of hood 122 mounts to a lower cooling package frame, and the upper mount rests on the windshield wiper cowl. This mounting configuration reduces the number and weight of components needed to mount the hood 122. The Oshkosh Corporation® logo is mounted to a frame structure, which is itself mounted directly to the cooling package. The hood 122 includes bumperettes 123 that provide mounting locations for antennas (e.g., a forward-facing IED jammer, a communications whip antenna, etc.). In one embodiment, the bumperettes 123 and front of the hood 122 may be reinforced (e.g., with structural fibers, structural frame members, etc.) to become structural members intended to prevent damage to the tire assemblies 600. In an alternative embodiment, the bumperettes 123 may be crushable members or “break away” members that disengage upon impact to prevent interference between the bumperettes 123 and tire assemblies 600 in the event of a front impact.

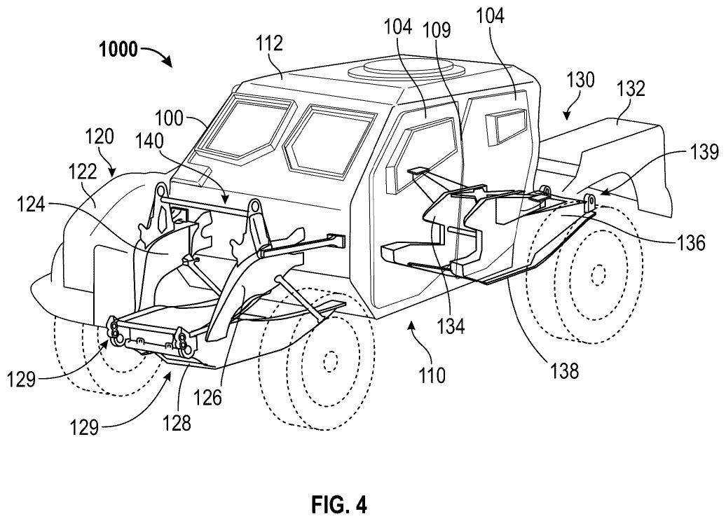

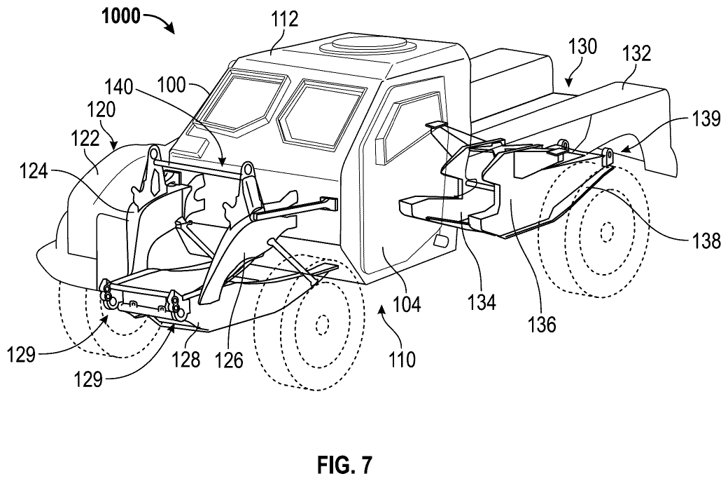

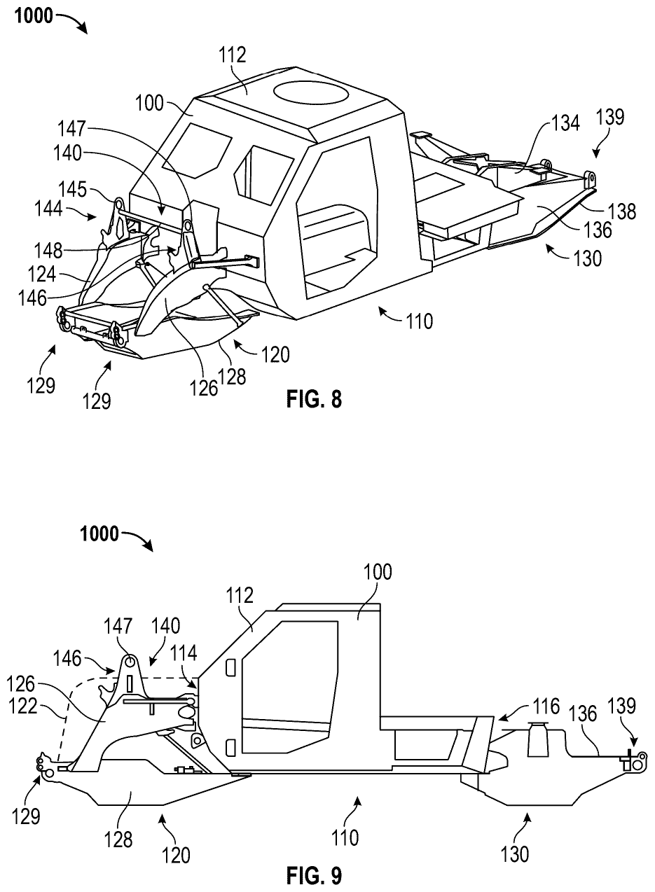

Referring next to the exemplary embodiment shown in FIGS. 4-9, the military vehicle 1000 includes passenger capsule 110, front module 120, and rear module 130. As shown in FIGS. 4 and 7, passenger capsule 110 includes a structural shell 112 that forms a monocoque hull structure. Monocoque refers to a form of vehicle construction in which the vehicle body and chassis form a single unit. The structural shell 112 is configured to provide a structural load path between front module 120 and rear module 130 of military vehicle 1000 (e.g., during driving, a lifting operation, during a blast event, etc.). According to an exemplary embodiment, the structural shell 112 includes a plurality of integrated armor mounting points configured to engage a supplemental armor kit (e.g., a “B-Kit,” etc.). The structural shell 112 is rigidly connected to the rest of the powertrain, drivetrain, suspension, and major systems such that they all absorb blast energy during a blast event, according to an exemplary embodiment. According to an exemplary embodiment, the structural shell 112 is large enough to contain four-passengers in a standard two-by-two seating arrangement and four doors 104 are rotatably mounted to the structural shell 112. According to the alternative embodiment shown in FIGS. 7-9, two doors 104 are coupled to structural shell 112. Front module 120 and rear module 130 are configured to engage a passenger capsule having either two doors or four doors, according to an exemplary embodiment. As shown in FIGS. 6 and 9, the structural shell 112 includes a first end 114 and a second end 116.

According to an exemplary embodiment, front module 120 includes a subframe having a first longitudinal frame member 124 and a second longitudinal frame member 126. As shown in FIGS. 4-9, an underbody support structure 128 is coupled to the first longitudinal frame member 124 and the second longitudinal frame member 126. According to an exemplary embodiment, the first longitudinal frame member 124 and the second longitudinal frame member 126 extend within a common plane (e.g., a plane parallel to a ground surface). The underbody support structure 128 is coupled to the first end 114 of structural shell 112 and includes a plurality of apertures 129 that form tie down points. In some embodiments, an engine for the military vehicle 1000 is coupled to the first longitudinal frame member 124 and the second longitudinal frame member 126. In other embodiments, the front module 120 includes a front axle assembly coupled to the first longitudinal frame member 124 and the second longitudinal frame member 126.

As shown in FIGS. 4 and 6, rear module 130 includes a subframe having a first longitudinal frame member 134 and a second longitudinal frame member 136. As shown in FIGS. 4-9, an underbody support structure 138 is coupled to the first longitudinal frame member 134 and the second longitudinal frame member 136. According to an exemplary embodiment, the first longitudinal frame member 134 and the second longitudinal frame member 136 extend within a common plane (e.g., a plane parallel to a ground surface). The underbody support structure 138 is coupled to the second end 116 of structural shell 112, the first longitudinal frame member 134, and the second longitudinal frame member 136. According to an exemplary embodiment, the first longitudinal frame member 134 and the second longitudinal frame member 136 include a plurality of apertures 139 that form tie down points. In some embodiments, a transaxle 450 or a differential for the military vehicle 1000 is coupled to at least one of the first longitudinal frame member 134 and the second longitudinal frame member 136. In other embodiments, the rear module 130 includes a rear axle assembly coupled to the first longitudinal frame member 134 and the second longitudinal frame member 136.

The subframes of the front module 120 and the rear module 130 may be manufactured from High Strength Steels (HSS), high strength aluminum, or another suitable material. According to an exemplary embodiment, the subframes feature a tabbed, laser cut, bent and welded design. In other embodiments, the subframes may be manufactured from tubular members to form a space frame. The subframe may also include forged, rather than fabricated or cast frame sections to mitigate the stress, strains, and impact loading imparted during operation of military vehicle 1000. Aluminum castings may be used for various cross member components where the loading is compatible with material properties. Low cost aluminum extrusions may be used to tie and box structures together.

The structural shell 112 and the subframes of the front module 120 and the rear module 130 are integrated into the hull and frame assembly 100 to efficiently carry chassis loading imparted during operation of the military vehicle 1000, during a lift event, during a blast event, or under still other conditions. During a blast event, conventional frame rails can capture the blast force transferring it into the vehicle. Military vehicle 1000 replaces conventional frame rails and instead includes passenger capsule 110, front module 120, and rear module 130. The passenger capsule 110, front module 120, and rear module 130 provides a vent for the blast gases (e.g., traveling upward after the tire triggers an IED) thereby reducing the blast force on the structural shell 112 and the occupants within passenger capsule 110. Traditional frame rails may also directly impact (i.e. contact, engage, hit, etc.) the floor of traditional military vehicles. Military vehicle 1000 that includes passenger capsule 110, front module 120, and rear module 130 does not include traditional frame rails extending along the vehicle's length thereby eliminating the ability for such frame rails to impact the floor of the passenger compartment. Military vehicle 1000 that includes a passenger capsule 110, front module 120, and rear module 130 also has an improved strength-to-weight performance, abuse tolerance, and life-cycle durability.

According to an exemplary embodiment, the doors 104 incorporate a combat lock mechanism. In some embodiments, the combat lock mechanism is controlled through the same handle that operates the automotive door latch system, allowing a passenger to release the combat locks and automotive latches in a single motion for quick egress. The doors 104 also interface with an interlocking door frame 109 defined within structural shell 112 adjacent to the latch, which helps to keep the doors 104 closed and in place during a blast even. Such an arrangement also distributes blast forces between a front and a rear door mounting and latching mechanism thereby improving door functionality after a blast event.

### Lift Structure

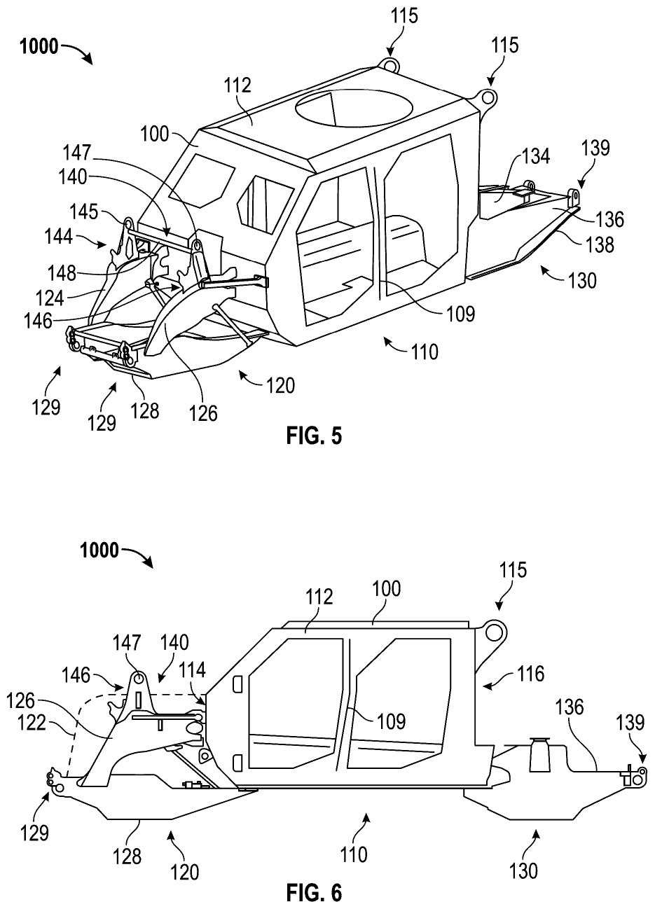

According to an exemplary embodiment, the military vehicle 1000 may be transported from one location to another in an elevated position with respect to a ground surface (e.g., during a helicopter lift operation, for loading onto or off a ship, etc.). As shown in FIGS. 4-9, military vehicle 1000 includes a lift structure 140 coupled to the front module 120. According to an exemplary embodiment, the lift structure includes a first protrusion 144 extending from the first longitudinal frame member 124, a second protrusion 146 coupled to the second longitudinal frame member 126, and a lateral frame member 148 extending between the first protrusion 144 and the second protrusion 146. As shown in FIGS. 4-9, the first protrusion 144 and the second protrusion 146 extend along an axis that is generally orthogonal (e.g., within 20 degrees of an orthogonal line) to a common plane within which the first longitudinal frame member 134 and the second longitudinal frame member 126 extend. As shown in FIGS. 5-6 and 8-9, the first protrusion 144 defines a first aperture 145, and the second protrusion 146 defines a second aperture 147. The first aperture 145 and the second aperture 147 define a pair of front lift points. An operator may engage the front lift points with a sling, cable, or other device to elevate military vehicle 1000 from a ground surface (e.g., for transport).

According to an exemplary embodiment, the hood 122 defines an outer surface (e.g., the surface exposed to a surrounding environment) and an inner surface (e.g., the surface facing the first longitudinal frame member 124 and the second longitudinal frame member 126). It should be understood that the outer surface is separated from the inner surface by a thickness of the hood 122. As shown schematically in FIGS. 4, 6-7, and 9, first protrusion 144 and second protrusion 146 extend through a first opening and a second opening defined within the hood 122. According to an exemplary embodiment, the pair of front lift points is positioned along the outer surface of the hood 122 (e.g., to provide preferred sling angles, to facilitate operator access, etc.).

According to an exemplary embodiment, the first longitudinal frame member 124 and the second longitudinal frame member 126 are coupled to the first end 114 of the structural shell 112 with a plurality of interfaces. Such interfaces may include, by way of example, a plurality of fasteners (e.g., bolts, rivets, etc.) extending through corresponding pads coupled to the front module 120 and the structural shell 112. According to an exemplary embodiment, a lifting force applied to the pair of front lift points is transmitted into the structural shell of the passenger capsule to lift the vehicle.

In some embodiments, the military vehicle 1000 includes breakaway sections designed to absorb blast energy and separate from the remaining components of military vehicle 1000. The blast energy is partially converted into kinetic energy as the breakaway sections travel from the remainder of military vehicle 1000 thereby reducing the total energy transferred to the passengers of military vehicle 1000. According to an exemplary embodiment, at least one of the front module 120 and the rear module 130 are breakaway sections. Such a military vehicle 1000 includes a plurality of interfaces coupling the front module 120 and the rear module 130 to passenger capsule 110 that are designed to strategically fail during a blast event. By way of example, at least one of the plurality of interfaces may include a bolted connection having a specified number of bolts that are sized and positioned (e.g., five 0.5 inch bolts arranged in a pentagon, etc.) to fail as an impulse force is imparted on front module 120 or rear module 130 during a blast event. In other embodiments, other components of the military vehicle 1000 (e.g., wheel, tire, engine, etc.) are breakaway sections.

Referring again to the exemplary embodiment shown in FIGS. 4-6, the military vehicle 1000 may be lifted by a pair of apertures defined within a pair of protrusions 115. The apertures define a pair of rear lift points for military vehicle 1000. As shown in FIG. 5, the pair of protrusions 115 extend from opposing lateral sides of the structural shell 112. It should be understood that a lifting force applied directly to the pair of protrusions 115 may, along with the lifting force applied to lift structure 140, elevate the military vehicle 1000 from a ground surface. The structural shell 112 carries the loading imparted by the lifting forces applied to the lift structure 140 (e.g., through the plurality of interfaces) and the pair of protrusions 115 to elevate the military vehicle 1000 from the ground surface without damaging the passenger capsule 110, the front module 120, or the rear module 130.

### Armor Assembly

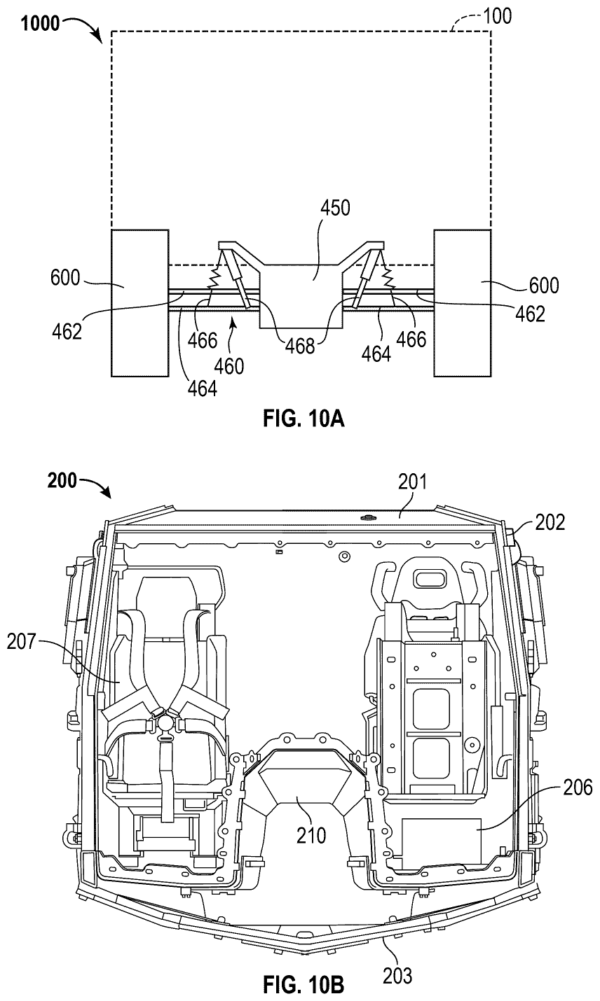

Referring next to the exemplary embodiment shown in FIG. 10, the armor assembly 200 includes fabricated subassemblies (roof, floor, sidewalls, etc.) that are bolted together. The armor assembly 200 may be manufactured from steel or another material. The armor assembly 200 provides a robust and consistent level of protection by using overlaps to provide further protection at the door interfaces, component integration seams, and panel joints.

In another embodiment, the armor assembly 200 further includes a 360-degree modular protection system that uses high hard steel, commercially available aluminum alloys, ceramic-based SMART armor, and two levels of underbody mine/improved explosive device (“IED”) protection. The modular protection system provides protection against kinetic energy projectiles and fragmentation produced by IEDs and overhead artillery fire. The modular protection system includes two levels of underbody protection. The two levels of underbody protection may be made of an aluminum alloy configured to provide an optimum combination of yield strength and material elongation. Each protection level uses an optimized thickness of this aluminum alloy to defeat underbody mine and IED threats.

Referring now to FIG. 10, the armor assembly 200 also includes a passenger capsule assembly 202. The passenger capsule assembly 202 includes a V-shaped belly deflector 203, a wheel deflector, a floating floor, footpads 206 and energy absorbing seats 207. The V-shaped belly deflector 203 is integrated into the sidewall. The V-shaped belly deflector 203 is configured to mitigate and spread blast forces along a belly. In addition, the wheel deflector mitigates and spreads blast forces. The “floating” floor utilizes isolators and standoffs to decouple forces experienced in a blast event from traveling on a direct load path to the passenger's lower limbs. The floating floor mounts to passenger capsule assembly 202 isolating the passenger's feet from direct contact with the blast forces on the belly. Moreover, footpads protect the passenger's feet. The energy absorbing seats 207 reduce shock forces to the occupants' hips and spine through a shock/spring attenuating system. The modular approach of the passenger capsule assembly 202 provides increased protection with the application of perimeter, roof and underbody add on panels. The components of the passenger capsule assembly 202 mitigate and attenuate blast effects, allow for upgrades, and facilitate maintenance and replacements.

The passenger capsule assembly 202 further includes a structural tunnel 210. For load purposes, the structural tunnel 210 replaces a frame or rail. The structural tunnel 210 has an arcuately shaped cross section and is positioned between the energy absorbing seats 207. The configuration of the structural tunnel 210 increases the distance between the ground and the passenger compartment of passenger capsule assembly 202. Therefore, the structural tunnel 210 provides greater blast protection from IEDs located on the ground because the IED has to travel a greater distance in order to penetrate the structural tunnel 210.

### Engine

The engine 300 is a commercially available internal combustion engine modified for use on military vehicle 1000. The engine 300 includes a Variable Geometry Turbocharger (VGT) configured to reduce turbo lag and improve efficiency throughout the engine 300's operating range by varying compressor housing geometry to match airflow. The VGT also acts as an integrated exhaust brake system to increase engine braking capability. The VGT improves fuel efficiency at low and high speeds and reduces turbo lag for a quicker powertrain response.

The engine 300 includes a glow plug module configured to improve the engine 300 cold start performance. In some embodiments, no ether starting aid or arctic heater is required. The glow plug module creates a significant system cost and weight reduction.

In addition, engine 300 includes a custom oil sump pickup and windage tray, which ensures constant oil supply to engine components. The integration of a front engine mount into a front differential gear box eliminates extra brackets, reduces weight, and improves packaging. Engine 300 may drive an alternator/generator, a hydraulic pump, a fan, an air compressor and/or an air conditioning pump. Engine 300 includes a top-mounted alternator/generator mount in an upper section of the engine compartment that allows for easy access to maintain the alternator/generator and forward compatibility to upgrade to a higher-power export power system. A cooling package assembly is provided to counteract extreme environmental conditions and load cases.

According to an exemplary embodiment, the military vehicle 1000 also includes a front engine accessory drive (FEAD) that mounts engine accessories and transfers power from a front crankshaft dampener/pulley to the accessory components through a multiple belt drive system. According to an exemplary embodiment, the FEAD drives a fan, an alternator, an air conditioning pump, an air compressor, and a hydraulic pump. There are three individual belt groups driving these accessories to balance the operational loads on the belt as well as driving them at the required speeds. A top-mounted alternator provides increased access for service and upgradeability when switching to the export power kit (e.g., an alternator, a generator, etc.). The alternator is mounted to the front sub frame via tuned isolators, and driven through a constant velocity (CV) shaft coupled to a primary plate of the FEAD. This is driven on a primary belt loop, which is the most inboard belt to the crank dampener. No other components are driven on this loop. A secondary belt loop drives the hydraulic pump and drive through pulley. This loop has one dynamic tensioner and is the furthest outboard belt on the crankshaft dampener pulley. This belt loop drives power to a tertiary belt loop through the drive through pulley. The tertiary belt loop drives the air conditioning pump, air compressor, and fan clutch. There is a single dynamic tensioner on this loop, which is the furthest outboard loop of the system.

### Transmission, Transfer Case, Differentials

Military vehicle 1000 includes a commercially available transmission 400. Transmission 400 also includes a torque converter configured to improve efficiency and decrease heat loads. Lower transmission gear ratios combined with a low range of an integrated rear differential/transfer case provide optimal speed for slower speeds, while higher transmission gear ratios deliver convoy-speed fuel economy and speed on grade. In addition, a partial throttle shift performance may be refined and optimized in order to match the power outputs of the engine 300 and to ensure the availability of full power with minimal delay from operator input. This feature makes the military vehicle 1000 respond more like a high performance pickup truck than a heavy-duty armored military vehicle.

The transmission 400 includes a driver selectable range selection. The transaxle 450 contains a differential lock that is air actuated and controlled by switches on driver's control panel. Indicator switches provide shift position feedback and add to the diagnostic capabilities of the vehicle. Internal mechanical disconnects within the transaxle 450 allow the vehicle to be either flat towed or front/rear lift and towed without removing the drive shafts. Mechanical air solenoid over-rides are easily accessible at the rear of the vehicle. Once actuated, no further vehicle preparation is needed. After the recovery operation is complete, the drive train is re-engaged by returning the air solenoid mechanical over-rides to the original positions.

The transaxle 450 is designed to reduce the weight of the military vehicle 1000. The weight of the transaxle 450 was minimized by integrating the transfercase and rear differential into a single unit, selecting an optimized gear configuration, and utilizing high strength structural aluminum housings. By integrating the transfercase and rear differential into transaxle 450 thereby forming a singular unit, the connecting drive shaft and end yokes traditionally utilized between to connect them has been eliminated. Further, since the transfercase and rear carrier have a common oil sump and lubrication system, the oil volume is minimized and a single service point is used. The gear configuration selected minimizes overall dimensions and mass providing a power dense design. The housings are cast from high strength structural aluminum alloys and are designed to support both the internal drive train loads as well as structural loads from the suspension system 460 and frame, eliminating the traditional cross member for added weight savings. According to the exemplary embodiment shown in FIG. 10A, at least a portion of the suspension system 460 (e.g., the upper control arm 462, the lower control arm 464, both the upper and lower control arms 462, 464, a portion of the spring 466, damper 468, etc.) is coupled to the transaxle 450. Such coupling facilitates assembly of military vehicle 1000 (e.g., allowing for independent assembly of the rear axle) and reduces the weight of military vehicle 1000. The front axle gearbox also utilizes weight optimized gearing, aluminum housings, and acts as a structural component supporting internal drive train, structural, and engine loads as well. The integrated transfercase allows for a modular axle design, which provides axles that may be assembled and then mounted to the military vehicle 1000 as a single unit. An integral neutral and front axle disconnect allows the military vehicle 1000 to be flat towed or front/rear lift and towed with minimal preparation. Further, the integrated design of the transaxle 450 reduces the overall weight of the military vehicle 1000. The transaxle 450 further includes a disconnect capability that allows the front tire assemblies 600 to turn without rotating the entire transaxle 450. Housings of the front and rear gearbox assembly are integrated structural components machined, for example, from high strength aluminum castings. Both front and rear gearbox housings provide stiffness and support for rear module 130 and the components of the suspension system 460.

### Suspension

The military vehicle 1000 includes a suspension system 460. The suspension system 460 includes high-pressure nitrogen gas springs 466 calibrated to operate in tandem with standard low-risk hydraulic shock absorbers 468, according to an exemplary embodiment. In one embodiment, the gas springs 466 include a rugged steel housing with aluminum end mounts and a steel rod. The gas springs 466 incorporate internal sensors to monitor a ride height of the military vehicle 1000 and provide feedback for a High Pressure Gas (HPG) suspension control system. The gas springs 466 and HPG suspension control system are completely sealed and require no nitrogen replenishment for general operation.

The HPG suspension control system adjusts the suspension ride height when load is added to or removed from the military vehicle 1000. The control system includes a high pressure, hydraulically-actuated gas diaphragm pump, a series of solenoid operated nitrogen gas distribution valves, a central nitrogen reservoir, a check valve arrangement and a multiplexed, integrated control and diagnostics system.

The HPG suspension control system shuttles nitrogen between each individual gas spring and the central reservoir when the operator alters ride height. The HPG suspension control system targets both the proper suspension height, as well as the proper gas spring pressure to prevent “cross-jacking” of the suspension and ensure a nearly equal distribution of the load from side to side. The gas diaphragm pump compresses nitrogen gas. The gas diaphragm pump uses a lightweight aluminum housing and standard hydraulic spool valve, unlike more common larger iron cast industrial stationary systems not suitable for mobile applications.

The suspension system 460 includes shock absorbers 468. In addition to their typical damping function, the shock absorbers 468 have a unique cross-plumbed feature configured to provide auxiliary body roll control without the weight impact of a traditional anti-sway bar arrangement. The shock absorbers 468 may include an equal area damper, a position dependent damper, and/or a load dependent damper.

### Brakes

The braking system 700 includes a brake rotor and a brake caliper. There is a rotor and caliper on each wheel end of the military vehicle 1000, according to an exemplary embodiment. According to an exemplary embodiment, the brake system includes an air over hydraulic arrangement. As the operator presses the brake pedal, and thereby operates a treadle valve, the air system portion of the brakes is activated and applies air pressure to the hydraulic intensifiers. According to an exemplary embodiment, military vehicle 1000 includes four hydraulic intensifiers, one on each brake caliper. The intensifier is actuated by the air system of military vehicle 1000 and converts air pressure from onboard military vehicle 1000 into hydraulic pressure for the caliper of each wheel. The brake calipers are fully-integrated units configured to provide both service brake functionality and parking brake functionality.

To reduce overall system cost and weight while increasing stopping capability and parking abilities, the brake calipers may incorporate a Spring Applied, Hydraulic Released (SAHR) parking function. The parking brake functionality of the caliper is created using the same frictional surface as the service brake, however the mechanism that creates the force is different. The calipers include springs that apply clamping force to the brake rotor to hold the military vehicle 1000 stationary (e.g. parking). In order to release the parking brakes, the braking system 700 applies a hydraulic force to compress the springs, which releases the clamping force. The hydraulic force to release the parking brakes comes through a secondary hydraulic circuit from the service brake hydraulic supply, and a switch on the dash actuates that force, similar to airbrake systems.

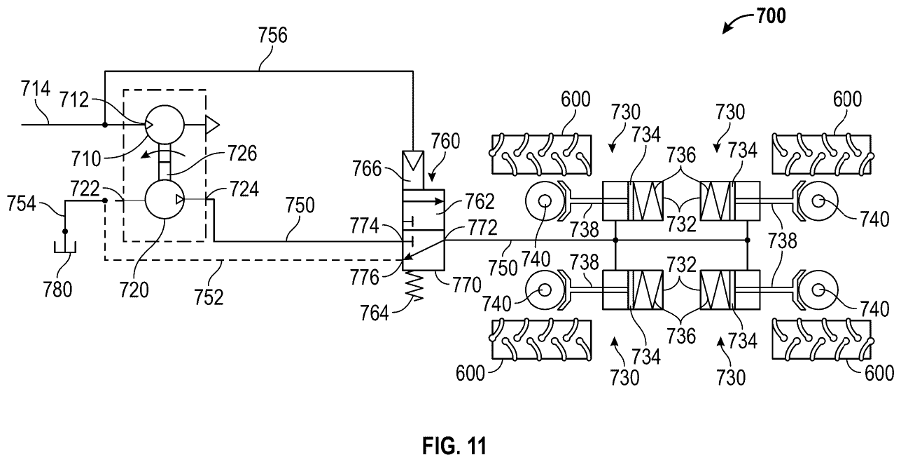

Referring specifically to the exemplary embodiment shown in FIG. 11, braking system 700 is shown schematically to include a motor 710 having a motor inlet 712. The motor 710 is an air motor configured to be driven by an air system of military vehicle 1000, according to an exemplary embodiment. The motor 710 may be coupled to the air system of military vehicle 1000 with a line 714. As shown in FIG. 11, braking system 700 includes a pump 720 that includes a pump inlet 722, a pump outlet 724, and a pump input shaft 726. The pump input shaft 726 is rotatably coupled to the motor 710 (e.g., an output shaft of the motor 710).

As shown in FIG. 11, braking system 700 includes a plurality of actuators 730 coupled to the pump outlet 724. According to an exemplary embodiment, the actuators 730 includes a housing 732 that defines an inner volume and a piston 734 slidably coupled to the housing 732 and separating the inner volume into a first chamber and a second chamber. The plurality of actuators 730 each include a resilient member (e.g., spring, air chamber, etc.), shown as resilient member 736 coupled to the housing and configured to generate a biasing force (e.g., due to compression of the resilient member 736, etc.). According to an exemplary embodiment, the plurality of actuators 730 each also include a rod 738 extending through an end of the housing 732. The rod 738 is coupled at a first end to piston 734 and coupled at a second end to a brake that engages a braking member (e.g., disk, drum, etc.), shown as braking member 740. As shown in FIG. 11, the rod is configured to apply the biasing force to the braking member 740 that is coupled to wheel and tire assemblies 600 thereby inhibiting movement of the military vehicle 1000.

According to an exemplary embodiment, a control is actuated by the operator, which opens a valve to provide air along the line 714. Pressurized air (e.g., from the air system of military vehicle 1000, etc.) drives motor 710, which engages pump 720 to flow a working fluid (e.g., hydraulic fluid) a through line 750 that couples the pump outlet 724 to the plurality of actuators 730. According to an exemplary embodiment, the pump 720 is a hydraulic pump and the actuator 730 is a hydraulic cylinder. Engagement of the pump 720 provides fluid flow through line 750 and into at least one of the first chamber and the second chamber of the plurality of actuators 730 to overcome the biasing force of resilient member 736 with a release force. The release force is related to the pressure of the fluid provided by pump 720 and the area of the piston 734. Overcoming the biasing force releases the brake thereby allowing movement of military vehicle 1000.

As shown in FIG. 11, braking system 700 includes a valve, shown as directional control valve 760, positioned along the line 750. According to an exemplary embodiment, directional control valve 760 includes a valve body 770. The valve body 770 defines a first port 772, a second port 774, and a reservoir port 776, according to an exemplary embodiment. When valve gate 762 is in the first position (e.g., pressurized air is not applied to air pilot 766) valve gate 762 places first port 772 in fluid communication with reservoir port 776. A reservoir 780 is coupled to the reservoir port 776 with a line 752. The reservoir 780 is also coupled to the pump inlet 722 with a line 754. It should be understood that the fluid may be forced into reservoir 780 from any number of a plurality of actuators 730 by resilient member 736 (e.g., when pump 720 is no longer engaged).

According to an exemplary embodiment, the directional control valve 760 selectively couples the plurality of actuators 730 to the pump outlet 724 or reservoir 780. The directional control valve 760 includes a valve gate 762 that is moveable between a first position and a second position. According to an exemplary embodiment, the valve gate 762 is at least one of a spool and a poppet. The valve gate 762 is biased into a first position by a valve resilient member 764. According to an exemplary embodiment, the directional control valve 760 also includes an air pilot 766 positioned at a pilot end of the valve gate 762. The air pilot 766 is coupled to line 714 with a pilot line 756. Pressurized air is applied to line 714 drives motor 710 and is transmitted to air pilot 766 to overcome the biasing force of valve resilient member 764 and slide valve gate 762 into a second position. In the second position, valve gate 762 places first port 772 in fluid communication with 774 thereby allowing pressurized fluid from pump 720 to flow into actuators 730 to overcome the biasing force of resilient member 736 and allow uninhibited movement of military vehicle 1000.

### Control System

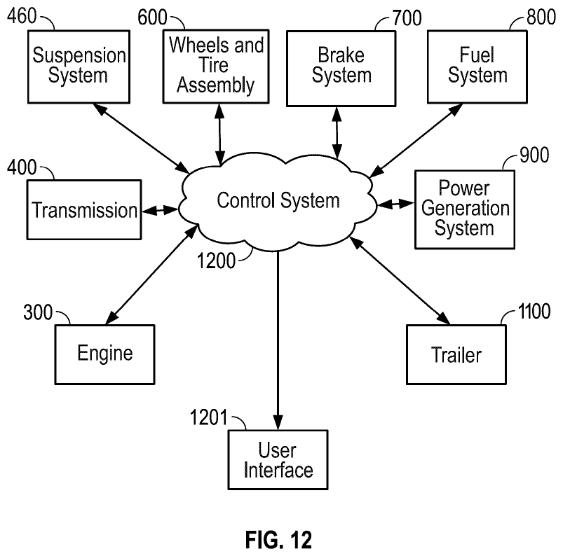

Referring to FIG. 12, the systems of the military vehicle 1000 are controlled and monitored by a control system 1200. The control system 1200 integrates and consolidates information from various vehicle subsystems and displays this information through a user interface 1201 so the operator/crew can monitor component effectiveness and control the overall system. For example, the subsystems of the military vehicle 1000 that can be controlled or monitored by the control system 1200 are the engine 300, the transmission 400, the transaxle 450, the suspension system 460, the wheels and tire assemblies 600, the braking system 700, the fuel system 800, the power generation system 900, and a trailer 1100. However, the control system 1200 is not limited to controlling or monitoring the subsystems mentioned above. A distributed control architecture of the military vehicle 1000 enables the control system 1200 process.

In one embodiment, the control system 1200 provides control for terrain and load settings. For example, the control system 1200 can automatically set driveline locks based on the terrain setting, and can adjust tire pressures to optimal pressures based on speed and load. The control system 1200 can also provide the status for the subsystems of the military vehicle 1000 through the user interface 1201. In another example, the control system 1200 can also control the suspension system 460 to allow the operator to select appropriate ride height.

The control system 1200 may also provide in-depth monitoring and status. For example, the control system 1200 may indicate on-board power, output power details, energy status, generator status, battery health, and circuit protection. This allows the crew to conduct automated checks on the subsystems without manually taking levels or leaving the safety of the military vehicle 1000.

The control system 1200 may also diagnose problems with the subsystems and provide a first level of troubleshooting. Thus, troubleshooting can be initiated without the crew having to connect external tools or leave the safety of the military vehicle 1000.

### Braking Enhancement System

### Overview

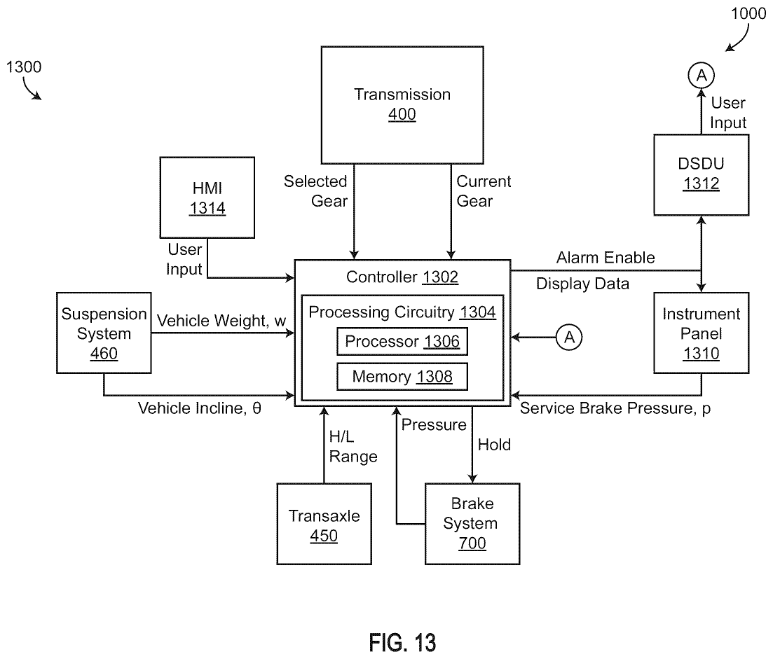

Referring to FIGS. 13-21B, the military vehicle 1000 can include, implement, be monitored by, be controlled by, etc., a braking system enhancement system (BSES) 1300. The BSES 1300 is configured to monitor various systems or sensors of the military vehicle 1000 (e.g., the suspension system 460, the transmission 400, an instrument panel 1310, the transaxle 450, etc.) and identify alert or alarm conditions. In some embodiments, the B SES 1300 is configured to operate the brake system 700 (e.g., to hold, maintain, or limit a current air pressure of the brake system 700, or to allow the air pressure of the brake system 700 to be adjusted). The BSES 1300 can use inputs including, but not limited to, a selected gear of the transmission 400, a current gear of the transmission 400, a weight of the military vehicle 1000, w, a current incline of the military vehicle 1000, 0, a percentage road grade, a direction of the road grade or the current incline of the military vehicle 1000 (e.g., + or −), a range of the transaxle 450 (e.g., the engaged transaxle range), a primary brake air supply pressure, p_{primary}, and a secondary brake air supply pressure p_{secondary}. In some embodiments, the BSES 1300 is transitionable between multiple different states in response to state transition conditions. In some embodiments, the different states of the BSES 1300 that the BSES 1300 is transitionable between include an inactive state, an enabled or active state, an alarm active state, an alarm dismissed state, or an alarm disabled state.

### Control System

Referring particularly to FIG. 13, the BSES 1300 includes a controller 1302 that is communicably coupled with the transmission 400, the suspension system 460, the transaxle 450, the brake system 700, and the instrument panel 1310. The controller 1302 may be configured to communicate with the suspension system 460, the transmission 400, the transaxle 450, the brake system 700, or the instrument panel 1310 through a Controller Area Network (CAN) bus of the military vehicle 1000.

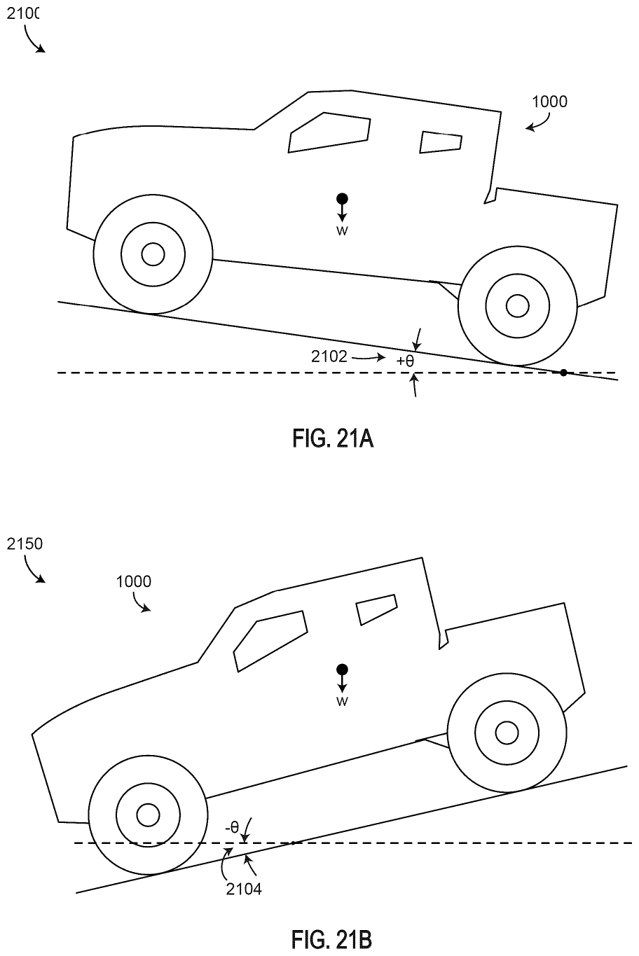

The controller 1302 is configured to obtain the vehicle weight, w, of the military vehicle 1000 and the incline of the vehicle 1000, or the grade of a surface upon which the military vehicle 1000 is currently. The weight of the military vehicle 1000 can be obtained from gas springs (e.g., the gas springs 466) of the suspension system 460. The gas springs 466 may include sensors that measure the ride height or weight of the military vehicle 1000. In some embodiments, a pressure of the gas springs 466 indicates the weight of the military vehicle 1000. The incline or the grade of the road, shown as e, can be obtained from an inclinometer of the suspension system 460, an inertial measurement unit (IMU) of the suspension system 460, ride height sensors of the suspension system 460, etc. The controller 1302 may also obtain a direction of the military vehicle 1000 (e.g., a positive incline as shown in FIG. 21A, or a negative incline as shown in FIG. 21B) that indicates if the military vehicle 1000 is driving uphill or downhill (e.g., on a positive grade surface or a negative grade surface, respectively). In some embodiments, the incline θ is obtained as an angular value of degrees, or is obtained as a percent grade. In some embodiments, the controller 1302 is configured to convert between the angular value of degrees of the incline θ and a corresponding percent grade value. It should be understood that any discussion of the incline θ herein may refer to either angular values in degrees or percent grade values. In some embodiments, the B SES 1300 is functional during operations (e.g., in drive or reverse) on longitudinal grades ranging from 5% to 60%, and provides warning or alarms so that the operator has sufficient time and braking pressure to stop the military vehicle 1000, and allow the brake pressure (e.g., p_{brake}) to re-pressurize to acceptable pressure levels to continue to hold the military vehicle 1000 stationary with pad/rotor temperatures of the brake system 700 no higher than 90 degrees Fahrenheit.

The transmission 400 can provide the selected gear (e.g., a gear selected by an operator or user of the military vehicle 1000) as feedback to the controller 1302. In some embodiments, the controller 1302 is configured to obtain the selected gear input from the instrument panel 1310 or a human machine interface (HMI) where the user or operator selects the vehicle. In some embodiments, the controller 1302 is configured to obtain the current gear input from the transmission 400 as feedback from the transmission 400. In some embodiments, if the current gear of the transmission 400 cannot be determined, the controller 1302 assumes a value of the current gear that is the same direction as the incline θ (e.g., positive incline means the controller 1302 uses a forwards gear, and negative incline means the controller 1302 uses a reverse gear).

In some embodiments, the controller 1302 is configured to provide an alarm enable command to the instrument panel 1310. The controller 1302 is configured to provide the alarm enable to the instrument panel 1310 in response to certain conditions so that the instrument panel 1310 can provide alarms to the operator of the military vehicle 1000. In some embodiments, the instrument panel 1310 is communicably coupled with input devices such as steering wheels, gear selectors, etc. The instrument panel 1310 can include a tachometer, alert lights, a fuel gauge, a speedometer, an engine temperature gauge, etc.

The brake system 700 can also provide current pressure of the brake system 700 to the controller 1302. In some embodiments, the current pressure of the brake system 700 is system air pressure and includes the primary brake air supply pressure, p_{primary}, and the secondary brake air supply pressure p_{secondary}. In some embodiments, the controller 1302 is configured to obtain the engaged transaxle range, shown as H/L range, from the transaxle 450.

In some embodiments, the controller 1302 is configured to receive the current gear of the transmission 400 from the transmission 400. In some embodiments, the controller 1302 is configured to receive the primary brake air supply pressure from the brake system 700 or a CAN bus of a chassis of the military vehicle 1000. In some embodiments, the controller 1302 is configured to receive the secondary brake air supply pressure from the brake system 700 or the CAN bus of the chassis of the military vehicle 1000. In some embodiments, the controller 1302 is configured to receive a dismiss signal from the CAN bus of the chassis of the military vehicle 1000. In some embodiments, the controller 1302 is configured to receive a disable signal from the CAN bus of the chassis of the military vehicle 1000. In some embodiments, the controller 1302 is configured to communicate with a driver side display unit (DSDU) 1312 and provide alarm or display data to the DSDU 1312. The controller 1302 can provide status information, state information, or textual information to the DSDU 1312 for display by the DSDU 1312 (e.g., using a display screen, a touch screen, etc.). In some embodiments, the DSDU 1312 includes an aural alert device (e.g., a speaker, a beeper, etc.) and/or a display screen (e.g., a touch screen) that can provide visual alerts and receive operator inputs (shown as user input). The controller 1302 can similarly receive user inputs from a human machine interface (HMI) 1314 of the military vehicle 1000.

The controller 1302 includes processing circuitry 1304, a processor 1360, and memory 1308. Processing circuitry 1304 can be communicably connected to a communications interface such that processing circuitry 1304 and the various components thereof can send and receive data via the communications interface. Processor 1306 can be implemented as a general purpose processor, an application specific integrated circuit (A SIC), one or more field programmable gate arrays (FPGAs), a group of processing components, or other suitable electronic processing components.

Memory 1308 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 1308 can be or include volatile memory or non-volatile memory. Memory 1308 can include database components, object code components, script components, or any other type of information structure for supporting the various activities and information structures described in the present application. According to some embodiments, memory 1308 is communicably connected to processor 1306 via processing circuitry 1304 and includes computer code for executing (e.g., by processing circuitry 1304 and/or processor 1306) one or more processes described herein.

In some embodiments, controller 1302 is implemented within a single computer (e.g., one server, one housing, etc.). In various other embodiments controller 1302 can be distributed across multiple servers or computers (e.g., that can exist in distributed locations). It should be understood that as used herein, any description of the controller 1302 performing operations, steps, functions, etc., may be performed by the processing circuitry 1304.

The controller 1302 is configured to obtain the primary and secondary brake air pressures (shown as service brake pressure, p) from the brake system 700 or the CAN bus of the chassis of the military vehicle 1000, and convert the brake air pressures to an appropriate unit of pressure. For example, if the primary and secondary brake air pressures are obtained in kPa, the controller 1302 may convert the primary and secondary brake air pressures to psi using the Equation shown:

$$y ( psi ) = 0.145 * x ( kPa )$$

In some embodiments, the controller 1302 is configured to determine a current brake air supply pressure, p_{brake} based on the primary brake air pressure and the secondary brake air pressure. In some embodiments, the controller 1302 determines the current brake air supply pressure p_{brake} by averaging the primary brake air pressure, p_{primary} and the secondary brake air pressure, p_{secondary}. For example, the controller 1302 can determine the average of the primary and secondary brake air pressures as shown below:

$${p}_{brake} = \frac{{p}_{primary} + {p}_{secondary}}{2}$$

In some embodiments, the controller 1302 is configured to determine an absolute value of the incline or grade, θ:

$${θ}_{a b s} = \vert θ \vert$$

In some embodiments, the controller 1502 is configured to update a minimum brake air supply pressure, pₘᵢₙ, (e.g., a threshold, a trigger value), using a lookup table at a default execution rate of the controller 1302 or the system 1300. In some embodiments, the controller 1302 is configured to update a non-volatile storage value of the weight w of the military vehicle 1000 in the memory 1308 if the weight of the military vehicle 1000 has changed by at least 1000 lbs since a previous update.

In some embodiments, the controller 1302 is configured to use a currently stored value (e.g., the non-volatile storage value of the weight w of the military vehicle 1000) as an input for any of the lookup tables shown below until the weight w of the military vehicle 1000 is obtained from the suspension system 460. In some embodiments, the controller 1302 is configured to use either the previously stored value of the weight w of the military vehicle 1000, or the currently obtained weight w of the military vehicle 1000 (whichever is currently available) to determine the minimum brake air supply pressure, pₘᵢₙ using the lookup tables shown below.

In some embodiments, the controller 1302 is configured to determine a gear value (e.g., forward or reverse) based on the current gear of the transmission 400 provided by the transmission 400. In some embodiments, the controller 1302 sets the gear value, g, to forward (e.g., g==+1) if:
the value of the current gear provided by the transmission 400 is greater than a predetermined value (e.g., 125), OR the value of the current gear has not been updated for at least a predetermined amount of time (e.g., 3 seconds); AND
the incline θ is greater than 0 (e.g., the sign of the incline θ is positive).

In some embodiments, the controller 1302 sets the gear value, g, to reverse (e.g., g==−1) if:
the value of the current gear provided by the transmission 400 is less than the predetermined value (e.g., 125), OR the value of the current gear has not been updated for at least the predetermined amount of time (e.g., 3 seconds); AND
the incline θ is less than 0 (e.g., the sign of the incline θ is negative).

### Minimum Pressure Determination

The controller 1302 is configured to determine a value of the minimum brake air supply pressure, p_{brake}, using one or more lookup tables, according to some embodiments. In some embodiments, the controller 1302 is configured to use different lookup tables based on conditions that are currently present. The controller 1302 generally uses three criteria or conditions to determine which of multiple lookup tables to use:
1. whether the H/L ratio of the transaxle 450 is high or low (H or L)
2. whether the incline θ is positive or negative (P or N); and
3. whether the transmission 400 is in a forwards or reverse gear (F or R)

Based on the above three criteria, it can be seen that eight different combinations of the three criteria are possible. Accordingly, the controller 1302 stores and uses (e.g., in the memory 1308) eight different lookup tables. It should be understood that while the present application describes the use of lookup tables and interpolation to determine values for the minimum brake air supply pressure pₘᵢₙ, the controller 1302 may alternatively use different sets of equations, different models, relationships, graphs, etc., to determine the value of the minimum air brake pressure pₘᵢₙ.

It should further be understood, that while each of the Tables 1-8 shown below include pressure values such as p_{min,1,1}, p_{min,2,1}, p_{min,3,1}, etc., these variables do not necessarily have the same values between the different tables. For example, the value of p_{min,1,1} in Table 1 may be different than the value of p_{min,1,1} in Table 3, the value of p_{min,1,2} in Table 1 may be different than the value of p_{min,1,2} in Table 5, etc. Generally speaking, the different tables illustrate different values, but overlap or equal values may occur between the different tables. For example, the value of p_{min,1,1} of Table 1 may be the same as the value of p_{min,1,1} of Table 3, but this is not necessarily the case. Accordingly, it should be understood that the different tables define different relationships (e.g., different curves) that may overlap with each other or be equal to each other at some points, but are not necessarily always identical or always different. Further, different models, weights, or configurations of the military vehicle 1000 may use different Tables 1-8 so that the BSES 1300 can be applied across a variety of military vehicles having different characteristics, configurations, weights, drivelines, etc. If the minimum brake air supply pressure pₘᵢₙ cannot be determined based on the Tables 1-8, the controller 1302 may operate the DSDU 1312 to provide an alarm, and the controller 1302 may log an event.

The minimum brake air supply pressure pₘᵢₙ can be a threshold or trigger amount so that, when the brake air supply pressure p_{brake} is equal to or less than the minimum brake air supply pressure pₘᵢₙ, the operator can be prompted to brake to fully stop the military vehicle 1000 and hold the military vehicle 1000 fully stopped until the brake air supply pressure p_{brake} has sufficiently recharged. In this way, the minimum brake air supply pressure pₘᵢₙ may be a warning that indicates continued operation of the military vehicle 1000 for transportation may result in inability to fully stop, unless the operator allows the brake system 700 time to re-pressurize (e.g., when the military vehicle 1000 is fully stopped). Advantageously, the alarms provided in response to the brake air supply pressure p_{brake} decreasing below the minimum brake air supply pressure pₘᵢₙ provide the operator sufficient time and braking abilities to fully stop the military vehicle 1000 and re-pressurize the brake system 700. In some embodiments, any alarms provided in response to the brake air supply pressure p_{brake} decreasing below the minimum brake air supply pressure pₘᵢₙ, are also prompts to the operator of the military vehicle 1000 to brake until the military vehicle 1000 comes to a complete stop, and to wait until the alarm is no longer provided (e.g., once the brake system 700 has sufficiently re-pressurized the brake air supply pressure p_{brake} above the minimum brake air supply pressure pₘᵢₙ).

In some embodiments, the controller 1302 is configured to use Table 1, shown below, to determine the value of the minimum brake air supply pressure pₘᵢₙ if all of the following conditions are met:
the H/L range provided by the transaxle 450 is currently “low” (L);
the incline θ of the military vehicle 1000 is positive (e.g., θ>0) (P); AND
the transmission 400 is currently in a forwards gear (e.g., the value of current gear provided by the transmission 400 is greater than 0) (F).
   If all of the above conditions are met, the controller 1302 determines or interpolates a value of the minimum brake air supply pressure, pₘᵢₙ, from Table 1, using the current weight w of the vehicle, and the incline θ:

TABLE 1
LPF Condition

Inclinometer Pitch (deg)

| LPF | | θ₁ | θ₂ | θ₃ | θ₄ |
|---|---|---|---|---|---|
| Vehicle | w₁ | p_{min, 1, 1} | p_{min, 2, 1} | p_{min, 3, 1} | p_{min, 4, 1} |
| Weight | w₂ | p_{min, 1, 2} | p_{min, 2, 2} | p_{min, 3, 2} | p_{min, 4, 2} |
| (lbs) | w₃ | p_{min, 1, 3} | p_{min, 2, 3} | p_{min, 3, 3} | p_{min, 4, 3} |
| | w₄ | p_{min, 1, 4} | p_{min, 2, 4} | p_{min, 3, 4} | p_{min, 4, 4} |
| | w₅ | p_{min, 1, 5} | p_{min, 2, 5} | p_{min, 3, 5} | p_{min, 4, 5} |
| | w₆ | p_{min, 1, 6} | p_{min, 2, 6} | p_{min, 3, 6} | p_{min, 4, 6} |
| | w₇ | p_{min, 1, 7} | p_{min, 2, 7} | p_{min, 3, 7} | p_{min, 4, 7} |

In some embodiments, if the weight of the vehicle 1000 and/or the incline θ of the military vehicle 1000 are not one of the weight values w₁, w₂, w₃, w₄, w₅, w₆, w₇, or one of the incline/pitch values θ₁, θ₂, θ₃, or θ₄, respectively, the controller 1302 can interpolate to determine a value of the minimum brake air supply pressure pₘᵢₙ. For example, if the weight of the military vehicle 1000 is w₅ (i.e., w=w₁) and the incline θ is θ₃ (i.e., θ=θ₃), then the controller 1302 selects the corresponding pressure value (i.e., pₘᵢₙ=p_{min,3,5}) for the minimum brake air supply pressure pₘᵢₙ. In some cases, the controller 1302 interpolates or extrapolates to determine values for the minimum brake air supply pressure based on the weight w of the military vehicle 1000 and the incline or pitch e, using the pressure values in Table 1.

The controller 1302 alternatively uses the Table 2, shown below, to determine the value of the minimum brake air supply pressure pₘᵢₙ When a second set of conditions are met. The second set of conditions are shown below:
the H/L range provided by the transaxle 450 is currently “low” (L);
the value of the incline θ is positive (P); AND
the transmission 400 is currently in a reverse gear (e.g., the value of the current gear provided by the transmission 400 is less than 0) (R).
   If all of the above conditions are met, the controller 1302 determines or interpolates a value of the minimum brake air supply pressure, pₘᵢₙ, from Table 2, using the current weight w of the vehicle, and the incline θ:

TABLE 2
LPR Condition

Inclinometer Pitch (deg)

| LPR | | θ₁ | θ₂ | θ₃ | θ₄ |
|---|---|---|---|---|---|
| Vehicle | w₁ | p_{min, 1, 1} | p_{min, 2, 1} | p_{min, 3, 1} | p_{min, 4, 1} |
| Weight | w₂ | p_{min, 1, 2} | p_{min, 2, 2} | p_{min, 3, 2} | p_{min, 4, 2} |
| (lbs) | w₃ | p_{min, 1, 3} | p_{min, 2, 3} | p_{min, 3, 3} | p_{min, 4, 3} |
| | w₄ | p_{min, 1, 4} | p_{min, 2, 4} | p_{min, 3, 4} | p_{min, 4, 4} |
| | w₅ | p_{min, 1, 5} | p_{min, 2, 5} | p_{min, 3, 5} | p_{min, 4, 5} |
| | w₆ | p_{min, 1, 6} | p_{min, 2, 6} | p_{min, 3, 6} | p_{min, 4, 6} |
| | w₇ | p_{min, 1, 7} | p_{min, 2, 7} | p_{min, 3, 7} | p_{min, 4, 7} |

The controller 1302 alternatively uses the Table 3, shown below, to determine the value of the minimum brake air supply pressure pₘᵢₙ When a third set of conditions are met. The third set of conditions are shown below:
the H/L range provided by the transaxle 450 is currently “low” (L);
the value of the incline θ is negative (N); AND
the transmission 400 is currently in a forwards gear (e.g., the value of the current gear provided by the transmission 400 is greater than 0) (F).
   If all of the above conditions are met, the controller 1302 determines or interpolates a value of the minimum brake air supply pressure, pₘᵢₙ, from Table 3, using the current weight w of the vehicle, and the incline θ:

TABLE 3
LNF Condition

Inclinometer Pitch (deg)

| LNF | | θ₁ | θ₂ | θ₃ | θ₄ |
|---|---|---|---|---|---|
| Vehicle | w₁ | p_{min, 1, 1} | p_{min, 2, 1} | p_{min, 3, 1} | p_{min, 4, 1} |
| Weight | w₂ | p_{min, 1, 2} | p_{min, 2, 2} | p_{min, 3, 2} | p_{min, 4, 2} |
| (lbs) | w₃ | p_{min, 1, 3} | p_{min, 2, 3} | p_{min, 3, 3} | p_{min, 4, 3} |
| | w₄ | p_{min, 1, 4} | p_{min, 2, 4} | p_{min, 3, 4} | p_{min, 4, 4} |
| | w₅ | p_{min, 1, 5} | p_{min, 2, 5} | p_{min, 3, 5} | p_{min, 4, 5} |
| | w₆ | p_{min, 1, 6} | p_{min, 2, 6} | p_{min, 3, 6} | p_{min, 4, 6} |
| | w₇ | p_{min, 1, 7} | p_{min, 2, 7} | p_{min, 3, 7} | p_{min, 4, 7} |

The controller 1302 alternatively uses the Table 4, shown below, to determine the value of the minimum brake air supply pressure pₘᵢₙ when a fourth set of conditions are met. The fourth set of conditions are shown below:
the H/L range provided by the transaxle 450 is currently “low” (L);
the value of the incline θ is negative (N); AND
the transmission 400 is currently in a reverse gear (e.g., a value of the current gear provided by the transmission 400 is less than 0) (R).
   If all of the above conditions are met, the controller 1302 determines or interpolates a value of the minimum brake air supply pressure, pₘᵢₙ, from Table 4, using the current weight w of the vehicle, and the incline θ:

TABLE 4
LNR Condition

Inclinometer Pitch (deg)

| LNR | | θ₁ | θ₂ | θ₃ | θ₄ |
|---|---|---|---|---|---|
| Vehicle | w₁ | p_{min, 1, 1} | p_{min, 2, 1} | p_{min, 3, 1} | p_{min, 4, 1} |
| Weight | w₂ | p_{min, 1, 2} | p_{min, 2, 2} | p_{min, 3, 2} | p_{min, 4, 2} |
| (lbs) | w₃ | p_{min, 1, 3} | p_{min, 2, 3} | p_{min, 3, 3} | p_{min, 4, 3} |
| | w₄ | p_{min, 1, 4} | p_{min, 2, 4} | p_{min, 3, 4} | p_{min, 4, 4} |
| | w₅ | p_{min, 1, 5} | p_{min, 2, 5} | p_{min, 3, 5} | p_{min, 4, 5} |
| | w₆ | p_{min, 1, 6} | p_{min, 2, 6} | p_{min, 3, 6} | p_{min, 4, 6} |
| | w₇ | p_{min, 1, 7} | p_{min, 2, 7} | p_{min, 3, 7} | p_{min, 4, 7} |

The controller 1302 alternatively uses the Table 5, shown below, to determine the value of the minimum brake air supply pressure pₘᵢₙ when a fifth set of conditions are met. The fifth set of conditions are shown below:
the H/L range provided by the transaxle 450 is currently “high” (H);
the value of the incline θ is positive (P); AND
the transmission 400 is currently in a forwards gear (e.g., a value of the current gear provided by the transmission 400 is greater than 0) (F).
   If all of the above conditions are met, the controller 1302 determines or interpolates a value of the minimum brake air supply pressure, pₘᵢₙ, from Table 5, using the current weight w of the vehicle, and the incline θ:

TABLE 5
HPF Condition

Inclinometer Pitch (deg)

| HPF | | θ₁ | θ₂ | θ₃ | θ₄ |
|---|---|---|---|---|---|
| Vehicle | w₁ | p_{min, 1, 1} | p_{min, 2, 1} | p_{min, 3, 1} | p_{min, 4, 1} |
| Weight | w₂ | p_{min, 1, 2} | p_{min, 2, 2} | p_{min, 3, 2} | p_{min, 4, 2} |
| (lbs) | w₃ | p_{min, 1, 3} | p_{min, 2, 3} | p_{min, 3, 3} | p_{min, 4, 3} |
| | w₄ | p_{min, 1, 4} | p_{min, 2, 4} | p_{min, 3, 4} | p_{min, 4, 4} |
| | w₅ | p_{min, 1, 5} | p_{min, 2, 5} | p_{min, 3, 5} | p_{min, 4, 5} |
| | w₆ | p_{min, 1, 6} | p_{min, 2, 6} | p_{min, 3, 6} | p_{min, 4, 6} |
| | w₇ | p_{min, 1, 7} | p_{min, 2, 7} | p_{min, 3, 7} | p_{min, 4, 7} |

The controller 1302 alternatively uses the Table 6, shown below, to determine the value of the minimum brake air supply pressure pₘᵢₙ when a sixth set of conditions are met. The sixth set of conditions are shown below:
the H/L range provided by the transaxle 450 is currently “high” (H);
the value of the incline θ is positive (P); AND
the transmission 400 is currently in a reverse gear (e.g., the value of the current gear provided by the transmission 400 is less than 0) (R).
   If all of the above conditions are met, the controller 1302 determines or interpolates a value of the minimum brake air supply pressure, pₘᵢₙ, from Table 6, using the current weight w of the vehicle, and the incline θ:

TABLE 6
HPR Condition

Inclinometer Pitch (deg)

| HPR | | θ₁ | θ₂ | θ₃ | θ₄ |
|---|---|---|---|---|---|
| Vehicle | w₁ | p_{min, 1, 1} | p_{min, 2, 1} | p_{min, 3, 1} | p_{min, 4, 1} |
| Weight | w₂ | p_{min, 1, 2} | p_{min, 2, 2} | p_{min, 3, 2} | p_{min, 4, 2} |
| (lbs) | w₃ | p_{min, 1, 3} | p_{min, 2, 3} | p_{min, 3, 3} | p_{min, 4, 3} |
| | w₄ | p_{min, 1, 4} | p_{min, 2, 4} | p_{min, 3, 4} | p_{min, 4, 4} |
| | w₅ | p_{min, 1, 5} | p_{min, 2, 5} | p_{min, 3, 5} | p_{min, 4, 5} |
| | w₆ | p_{min, 1, 6} | p_{min, 2, 6} | p_{min, 3, 6} | p_{min, 4, 6} |
| | w₇ | p_{min, 1, 7} | p_{min, 2, 7} | p_{min, 3, 7} | p_{min, 4, 7} |

The controller 1302 alternatively uses the Table 7, shown below, to determine the value of the minimum brake air supply pressure pₘᵢₙ when a seventh set of conditions are met. The seventh set of conditions are shown below:
the H/L range provided by the transaxle 450 is currently “high” (H);
the value of the incline θ is positive (P); AND
the transmission 400 is currently in a reverse gear (e.g., the value of the current gear provided by the transmission 400 is less than 0) (R).
   If all of the above conditions are met, the controller 1302 determines or interpolates a value of the minimum brake air supply pressure, pₘᵢₙ, from Table 7, using the current weight w of the vehicle, and the incline θ:

TABLE 7
HNF Condition

Inclinometer Pitch (deg)

| HNF | | θ₁ | θ₂ | θ₃ | θ₄ |
|---|---|---|---|---|---|
| Vehicle | w₁ | p_{min, 1, 1} | p_{min, 2, 1} | p_{min, 3, 1} | p_{min, 4, 1} |
| Weight | w₂ | p_{min, 1, 2} | p_{min, 2, 2} | p_{min, 3, 2} | p_{min, 4, 2} |
| (lbs) | w₃ | p_{min, 1, 3} | p_{min, 2, 3} | p_{min, 3, 3} | p_{min, 4, 3} |
| | w₄ | p_{min, 1, 4} | p_{min, 2, 4} | p_{min, 3, 4} | p_{min, 4, 4} |
| | w₅ | p_{min, 1, 5} | p_{min, 2, 5} | p_{min, 3, 5} | p_{min, 4, 5} |
| | w₆ | p_{min, 1, 6} | p_{min, 2, 6} | p_{min, 3, 6} | p_{min, 4, 6} |
| | w₇ | p_{min, 1, 7} | p_{min, 2, 7} | p_{min, 3, 7} | p_{min, 4, 7} |

The controller 1302 alternatively uses the Table 8, shown below, to determine the value of the minimum brake air supply pressure pₘᵢₙ when an eighth set of conditions are met. The eighth set of conditions are shown below:
the H/L range provided by the transaxle 450 is currently “high” (H);
the value of the incline θ is negative (N); AND
the transmission 400 is currently in a reverse gear (e.g., a value of the current gear provided by the transmission 400 is less than 0) (R).

If all of the above conditions are met, the controller 1302 determines or interpolates a value of the minimum brake air supply pressure, pₘᵢₙ, from Table 8, using the current weight w of the vehicle, and the incline θ:

TABLE 8
HNR Condition

Inclinometer Pitch (deg)

| HNR | | θ₁ | θ₂ | θ₃ | θ₄ |
|---|---|---|---|---|---|
| Vehicle | w₁ | p_{min, 1, 1} | p_{min, 2, 1} | p_{min, 3, 1} | p_{min, 4, 1} |
| Weight | w₂ | p_{min, 1, 2} | p_{min, 2, 2} | p_{min, 3, 2} | p_{min, 4, 2} |
| (lbs) | w₃ | p_{min, 1, 3} | p_{min, 2, 3} | p_{min, 3, 3} | p_{min, 4, 3} |
| | w₄ | p_{min, 1, 4} | p_{min, 2, 4} | p_{min, 3, 4} | p_{min, 4, 4} |
| | w₅ | p_{min, 1, 5} | p_{min, 2, 5} | p_{min, 3, 5} | p_{min, 4, 5} |
| | w₆ | p_{min, 1, 6} | p_{min, 2, 6} | p_{min, 3, 6} | p_{min, 4, 6} |
| | w₇ | p_{min, 1, 7} | p_{min, 2, 7} | p_{min, 3, 7} | p_{min, 4, 7} |

The minimum brake air pressure pₘᵢₙ is used by the controller 1302 to determine if the current brake air supply pressure, p_{brake} (e.g., a value determined based on the primary brake pressure p_{primary} and the secondary brake pressure p_{secondary} such as the average or mean) is greater than the minimum brake air pressure pₘᵢₙ, in which case the current operational status of the brake system 700 is acceptable (and consequently no warning or alarms are provided), or to determine if the current brake air supply pressure, p_{brake} is less than or below the minimum brake air pressure pₘᵢₙ, in which case the current operational status of the brake system 700 is unacceptable (e.g., the primary brake pressure p_{primary} and/or the secondary brake pressure p_{secondary} are too low). If the current operational status of the brake system 700 is unacceptable (e.g., the current brake air supply pressure p_{brake} is less than the minimum brake air pressure pₘᵢₙ, p_{brake}<pₘᵢₙ), the controller 1302 may provide an alarm to the operator or user.

### Inactive State

The controller 1302 is configured to transition out of a current state and into the inactive state if any of the following are true:
The H/L range of the transaxle 450 of the military vehicle 1000 is unknown;
The weight, w, of the military vehicle 1000 exceeds a maximum or threshold amount;
The incline, θ is greater than or less than corresponding maximum and minimum thresholds (e.g., greater than a maximum θₘₐₓ or less than a minimum θₘᵢₙ) such as +32 or −32 degrees, respectively;
The primary brake air pressure, p_{primary}, is outside of a predetermined range (e.g., p_{primary}>p_{primary,max} or p_{primary}<p_{primary,min}) such as greater than 2000 kPa or less than 0 kPa; or
The secondary brake air pressure, p_{secondary}, is outside of a predetermined range (e.g., p_{secondary}>p_{secondary,max} of p_{secondary}<p_{secondary,min}) such as greater than 2000 kPa or less than 0 kPa.

In some embodiments, the controller 1302 is configured only transition into the inactive state, if both (i) at least one of the above conditions are true, and (ii) braking enhancement of the system 1300 is not disabled by the user or operator.

In some embodiments, the controller 1302 is configured to transition out of the current state into the inactive state if the controller 1302 loses communication with any of the following for an amount of time greater than a predetermined amount (e.g., three seconds):
The DSDU 1312;
The signal associated with the primary air brake pressure, p_{primary}; or
The signal associated with the secondary air brake pressure, p_{secondary}.

In some embodiments, the controller 1302 is configured to transition out of the current state into the inactive state if both (i) any of the above three conditions are true, and (ii) the system 1300 is not disabled by the user or operator.

In some embodiments, the controller 1302 is configured to transition into the inactive state if the weight w of the military vehicle 1000 cannot be determined. In some embodiments, the controller 1302 is configured to transition into the inactive state if the range of the transaxle 450 cannot be obtained. In some embodiments, the controller 1302 is configured to transition into the inactive state if the incline θ cannot be determined. In some embodiments, the controller 1302 is configured to transition into the inactive state if the direction of the incline θ (e.g., positive or negative) cannot be determined.

When the controller 1302 is in the inactive state, the controller 1302 may activate the DSDU 1312 so that the DSDU 1312 can provide text alerts to the operator or user of the military vehicle 1000. In some embodiments, when the controller 1302 is in the inactive state, the controller 1302 is also configured to adjust an alarm signal so that no alarm signal is provided to the instrument panel 1310 or the DSDU 1312. The controller 1302 may also clear other internal fault parameters when transitioned into the inactive state. In some embodiments, the controller 1302 is also configured to change an internal state parameter of the controller 1302 or the system 1300 to inactive, and provide display data to at least one of the DSDU 1312 or the instrument panel 1310 so that the DSDU 1312 and/or the instrument panel 1310 may display that the current state of the system 1300 is inactive.

### Enabled State

In some embodiments, the controller 1302 is configured to transition out of the current state and into the enabled state if any one of the following conditions are true:
the current brake air supply pressure, p_{brake} is greater than a minimum of (i) a predetermined pressure value (e.g., 125 psi) or (ii) the minimum brake air supply pressure+15 (e.g., whichever of 125 psi or pₘᵢₙ+15 is less); or
the current brake air supply pressure, p_{brake}, is greater than the minimum brake air supply pressure+1 (e.g., p_{brake}>pₘᵢₙ+1) AND the minimum brake air supply pressure is ≥125 psi.

In some embodiments, the controller 1302 is configured to transition out of the current state and into the enable state if both (i) any of the above conditions are true, and (ii) the status of the system 1300 or the controller 1302 is currently the alarm active or the alarm active dismissed state. In this way, the controller 1302 may only transition into the enabled state from the alarm active or the alarm active dismissed state.

When the controller 1302 and/or the system 1300 are in the enabled state, the controller 1302 operates the DSDU 1312 and/or the instrument panel 1310 to indicate that the braking system enhancements (BSE) are currently enabled. The controller 1302 operates the DSDU 1312 and/or the instrument panel 1310 so that the DSDU 1312 and the instrument panel 1310 do not provide an alarm or alert display (e.g., by providing appropriate display data to the DSDU 1312 and/or the instrument panel 1310). The controller 1302 can also adjust an internal parameter of the system 1300, or a parameter of the DSDU 1312, or the instrument panel 1310, so that no alarm condition is currently present.

In some embodiments, the controller 1302 is configured to perform the calculations described in greater detail above continually during the enabled mode. For example, the controller 1302 may continually, while the military vehicle 1000 is driven, transported, or otherwise operated during the enabled state: (i) obtain the primary and secondary brake air pressures, (ii) determine the current brake air supply pressure p_{brake}, (iii) obtain the H/L range from the transaxle 450, (iv) obtain the current gear from the transmission 400, (v) obtain the vehicle weight w from the suspension system 460, (vi) obtain the incline θ, (vii) determine which of the Tables 1-8 to use based on current conditions (e.g., based on whether the H/L ratio of the transaxle 450 is high or low, whether the incline θ is positive or negative, and whether the transmission 400 is in a forwards or reverse gear), (viii) determine the minimum brake air supply pressure pₘᵢₙ, and (ix) compare the current brake air supply pressure p_{brake} to the minimum brake air supply pressure pₘᵢₙ to determine if the current brake air supply pressure is less than the minimum brake air supply pressure (e.g., an alarm condition).

### Alarm Active State

In some embodiments, the controller 1302 is configured to transition into the alarm active state if the brake air supply pressure, p_{brake}, is less than the minimum brake air supply pressure pₘᵢₙ. In some embodiments, the controller 1302 transitions out of the enabled state and into the alarm active state in response to the brake air supply pressure being less than the minimum brake air supply pressure (e.g., in response to p_{brake}<pₘᵢₙ). In some embodiments, the controller 1302 is configured to transition into the alarm active state only if the controller 1302 is not currently in the alarm active state.

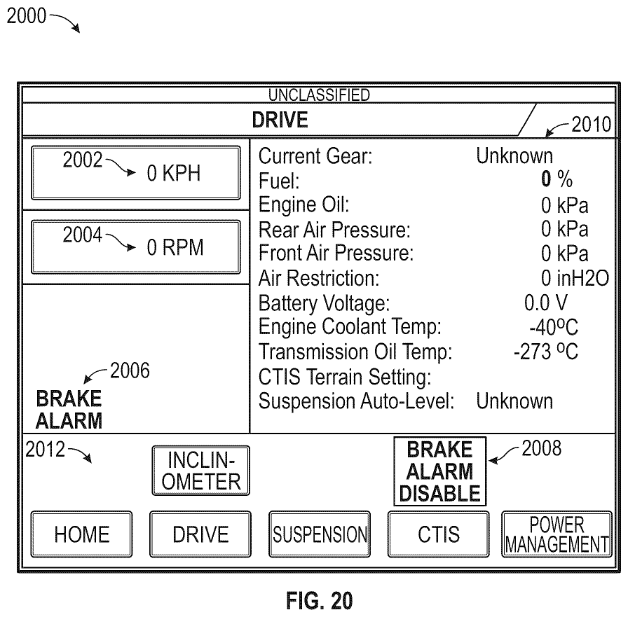

When the controller 1302 is transitioned into the alarm active state due to the brake air supply pressure, p_{brake}, being less than the minimum brake air supply pressure pₘᵢₙ, the controller 1302 operates the instrument panel 1310 and/or the DSDU 1312 to provide a visual and/or aural alert to the operator or user that the current brake air supply pressure p_{brake} is too low (e.g., is less than the minimum brake air supply pressure pₘᵢₙ). In some embodiments, the controller 1302 is configured to operate the instrument panel 1310 and/or the DSDU 1312 to provide a continuous alert (e.g., a continuous visual alert). The visual alert may include activating a light on the instrument panel 1310 (e.g., the brake alarm 2006 as shown in FIG. 20) so that the operator is notified that the current brake air supply pressure p_{brake} is too low.

In the alarm active state, the controller 1302 can operate an aural alert device of the military vehicle 1000 (e.g., an aural alert device of the HMI 1314, the DSDU 1312, the instrument panel 1310, etc.) to provide an audible alert to the operator. In some embodiments, the DSDU 1312, the instrument panel 1310, and/or the HMI 1314 are positioned within the passenger capsule 110 of the military vehicle 1000 (e.g., within a cabin or a cab of the military vehicle 1000).

In the alarm active state, the controller 1302 can operate the DSDU 1312 or the instrument panel 1310 to provide a textual alert to the operator. The DSDU 1312 may also provide an option to the operator to dismiss the alarm. The DSDU 1312 may also provide an option to the operator to disable the BSES 1300.

In some embodiments, the controller 1302 does not operate the DSDU 1312 to provide a visual alarm or alert when in the alarm active state and only provides an aural alert to the operator of the military vehicle 1100.

### Alarm Dismissed State

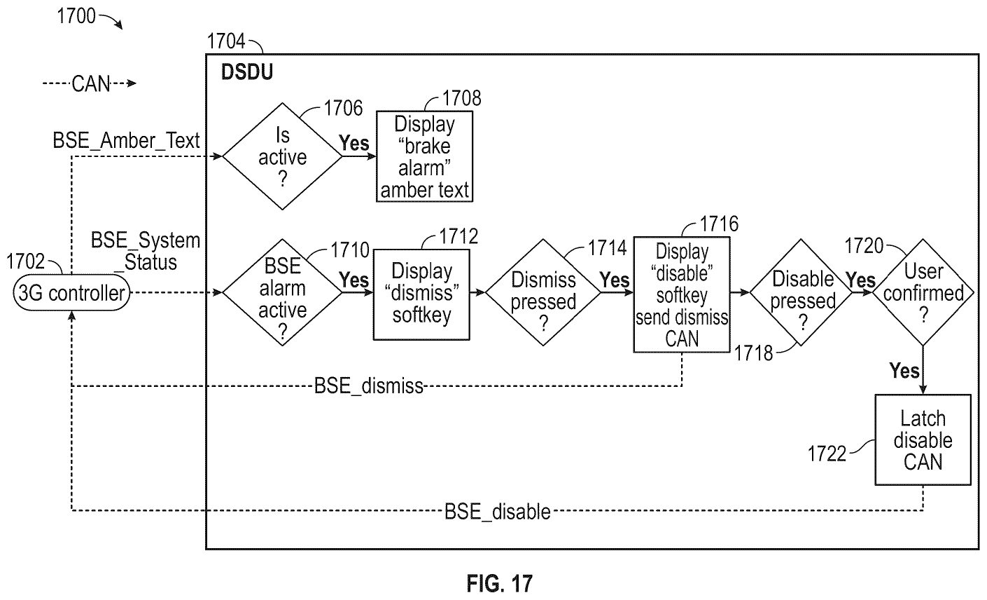

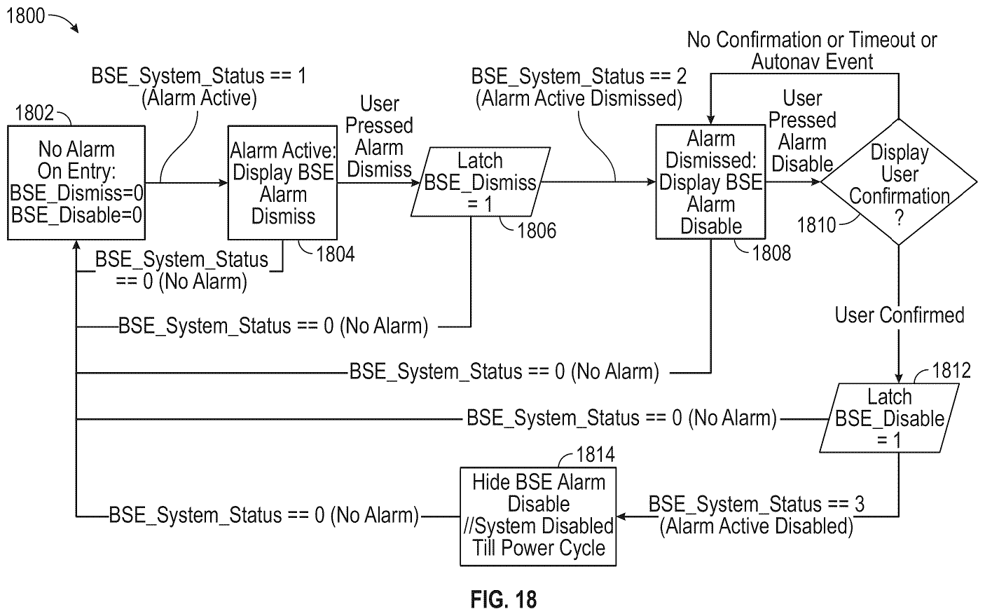

In some embodiments, the controller 1302 is configured to transition into the alarm dismissed state in response to a command provided by the operator via the DSDU 1312. FIGS. 17-18 and the associated description below provide additional details regarding the reception of the command to dismiss the alarm or to disable the BSES 1300. When the alarm is dismissed, the controller 1302 can operate the DSDU 1312, the instrument panel 1310, or the HMI 1314 to cease providing the alarm (e.g., the visual or the aural alarm) to the operator. In some embodiments, the controller 1302 also operates the instrument panel 1310 or the DSDU 1312 to notify the operator that the alarm has been dismissed. In some embodiments, the controller 1302 is configured to transition out of the alarm dismissed state and back into the alarm active state after the alarm is dismissed and when conditions that caused the alarm are cleared (e.g., once the brake air supply pressure p_{brake} is greater than the minimum brake air supply pressure pₘᵢₙ). In some embodiments, the controller 1302 only operates the DSDU 1312 or the instrument panel 1310 to provide an aural alert and does not provide a visual alert. In some embodiments, a button previously presented on the DSDU 1312 for dismissal of the alarm is changed to a disable button upon transitioning into the alarm dismissed state.

### Alarm Disabled State

In some embodiments, the controller 1302 is configured to transition into the alarm disabled state in response to receiving a command from the operator to disable the BSES 1300 or the controller 1302. In some embodiments, the controller 1302 is configured to transition into the alarm disabled state in response to both the command and a confirmation from the operator. For example, the controller 1302 may operate the DSDU 1312 to provide a confirmation screen to the operator to prompt the operator to confirm disablement of the BSES 1300. In some embodiments, when the controller 1302 is in the alarm disabled state, additional alarms are not provided to the operator even if the current brake air supply pressure p_{brake} is less than the minimum brake air supply pressure pₘᵢₙ. In some embodiments, in the alarm disabled state, the controller 1302 only provides textual alerts to the operator via the instrument panel 1310 or the DSDU 1312, but does not provide aural or audible alerts. In some embodiments, if the controller 1302 transitions into the alarm disabled state, the controller 1302 may log an event.

### Predicted Values

In some embodiments, the controller 1302 is configured to perform any of the above described functionality to determine if a requested gear selection (e.g., at the transmission 400) or if a selected transition of the transaxle 450 between the high and low range should be allowed. The controller 1302 can use the selected gear in place of the current gear (e.g., whether the selected gear is forwards or reverse), and a requested transition of the transaxle 450 (e.g., high or low, as indicated by a request provided by the operator) to determine if the transmission 400 military vehicle 1000 should be transitioned to the selected gear or if the transaxle 450 of the military vehicle 1000

The controller 1302 can also be configured to obtain a current speed or velocity v of the military vehicle 1000 and use the current speed or velocity v of the military vehicle 1000 to determine if sufficient braking pressure is currently present. In some embodiments, the controller 1302 is configured to obtain a speed of wheels or tractive elements of the military vehicle 1000. In some embodiments, the controller 1302 is configured to limit additional acceleration of the military vehicle 1000 in response to determining that a higher speed of the military vehicle 1000 will result in inability to stop fully (e.g., in response to determining that a predicted brake air supply pressure p_{brake} will be less than the minimum brake air supply pressure pₘᵢₙ).

It should be understood that any of the inputs of the controller 1302 or any of the parameters determined by the controller 1302 (e.g., the minimum brake air supply pressure pₘᵢₙ) can be predicted parameters instead of current parameters. In some embodiments, the controller 1302 is configured to operate the brake system 700 to hold until the current brake air supply pressure p_{brake} has built up to be sufficiently greater than the minimum brake air supply pressure pₘᵢₙ.

### Alarm Process

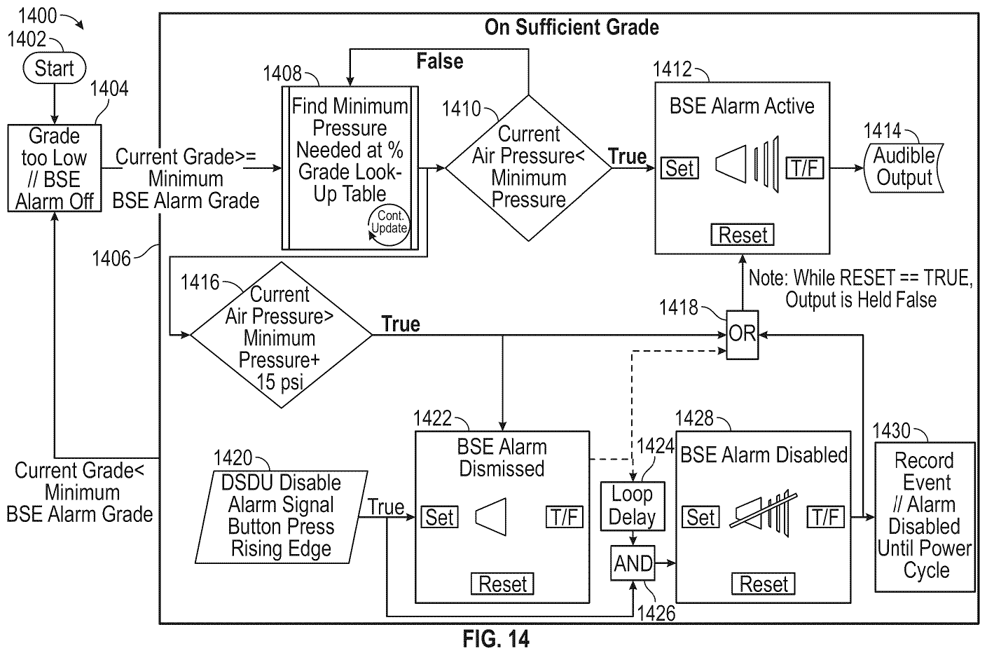

Referring to FIG. 14, a flow diagram of a process 1400 for providing an alarm to an operator of the military vehicle 1000 includes steps 1402-1430 and may be performed by the controller 1302, or more generally, by the system 1300 to provide brake air pressure alerts to the operator, driver, or user of the military vehicle 1000. Process 1400 begins at step 1402 (e.g., when initiated in response to the military vehicle 1000 being powered on), and proceeds to step 1404.

Process 1400 includes determining if an incline of the military vehicle 1000 is less than a threshold amount (step 1404), according to some embodiments. Step 1404 may be performed by the controller 1302. Step 1404 can include obtaining the incline θ from the suspension system 460, and comparing the incline θ to a threshold incline θ_{threshold}. If the incline or grade θ is greater than or equal to the threshold incline θ_{threshold} (e.g., a minimum grade or incline amount), process 1400 proceeds to steps 1406, or more particularly, to step 1408. If the incline or grade θ is less than the threshold incline θ_{threshold}, this may indicate that the current incline or grade is too low, and alarm functionality may be shut off (e.g., by the controller 1302).

Process 1400 includes determining a minimum pressure (e.g., pₘᵢₙ) that is needed at the incline or grade θ based on a grade look-up table (step 1408), according to some embodiments. In some embodiments, step 1408 includes performing the functionality as described in greater detail above with reference to Tables 1-8 to determine the minimum brake air pressure pₘᵢₙ based on the current brake air supply pressure p_{brake}, the weight w of the vehicle 1000, and the incline or grade. In some embodiments, step 1408 is performed continuously (e.g., at regular intervals) to continually refresh the value of the minimum brake air supply pressure pₘᵢₙ. In some embodiments, step 1408 includes performing interpolation of the values of any of Tables 1-8. Step 1408 can also include selecting one of Tables 1-8 for use based on the current conditions, as described in greater detail above with reference to Tables 1-8. In some embodiments, step 1408 is performed by the controller 1302.

Process 1400 includes determining if the current air pressure (i.e., the current brake air supply pressure, p_{brake}) is less than the minimum pressure (i.e., the minimum brake air supply pressure pₘᵢₙ as determined in step 1408), according to some embodiments. If the current air pressure is less than the minimum pressure (step 1410, “TRUE”), process 1400 proceeds to step 1412 and provides an alarm, since this indicates that an alarm should be provided to the user (e.g., the current air pressure is too low). If the current air pressure is greater than the minimum pressure (step 1410, “FALSE”), process 1400 returns to step 1408. In some embodiments, step 1410 is performed by the controller 1302.

Process 1400 includes transitioning into an alarm active state (step 1412) and either setting or triggering the alarm (step 1414), or resetting the alarm, according to some embodiments. In some embodiments, the alarm is only triggered when the current air pressure (e.g., p_{brake}) is less than the minimum pressure (e.g., pₘᵢₙ) (step 1410, “TRUE”). If the alarm is triggered due to the current air pressure being less than the minimum pressure, then process 1400 includes providing an alarm (step 1414) to the operator of the military vehicle 1000. The alarm can be a visual or an audible alarm. In some embodiments, the alarm is provided by operation of the DSDU 1312, or by operation of a light of the instrument panel 1310. The alarm may be held on until either dismissed by the operator or until the current air pressure exceeds the minimum pressure by at least 15 psi or any other predetermined amount (step 1416).

Process 1400 includes determining if the current air pressure is greater than the minimum pressure by at least 15 psi (or any other predetermined amount) (step 1416), according to some embodiments. If the current air pressure is greater than the minimum pressure by at least 15 psi or some other predetermined amount (e.g., p_{brake}>pₘᵢₙ+Δp, step 1416 “TRUE”), this may indicate that the brake pressure is now at a sufficient level, and process 1400 may reset any alarms provided at steps 1412 or 1414.

If any of (i) the current air pressure exceeds the minimum pressure by at least 15 psi or any other predetermined amount, (ii) the alarm is dismissed, or (iii) the alarm is disabled (see step 1418), process 1400 resets the alarm provided to the user or operator (e.g., at steps 1412 and 1414).

Process 1400 includes monitoring the DSDU 1312, monitoring an alarm signal, monitoring the depression of a particular button, and monitoring rate of change of the current air pressure (e.g., p_{brake}) (step 1420), according to some embodiments. In some embodiments, if the DSDU 1312 loses connection with the controller 1302, the alarm signal ceases, the particular button is depressed by the user, or the current air pressure is sufficiently rising or is above the minimum pressure, process 1400 proceeds to the alarm dismissed step/state 1422 and the alarm is dismissed. If the current air pressure is greater than the minimum pressure by at least 15 psi or by at least another predetermined amount (step 1416, “TRUE”), the alarm is reset (step 1422, “RESET”). If the alarm has been dismissed (step/state 1422), the alarm has been dismissed for a predetermined amount of time (step 1424), and any of the conditions described with reference to step 1420 are true (step 1426), process 1400 proceeds to step 1428 and the alarm is disabled. In some embodiments, once the alarm is disabled, process 1400 includes recording the alarm disablement event and maintaining the alarm in the disabled state until power is cycled (step 1430) (e.g., until alarm functionality is re-activated or until the appropriate conditions for automatic activation of the alarm are met). In some embodiments, once the alarm is disabled, process 1400 proceeds to step 1412 and resets any currently provided alarms.

### State Transition Process

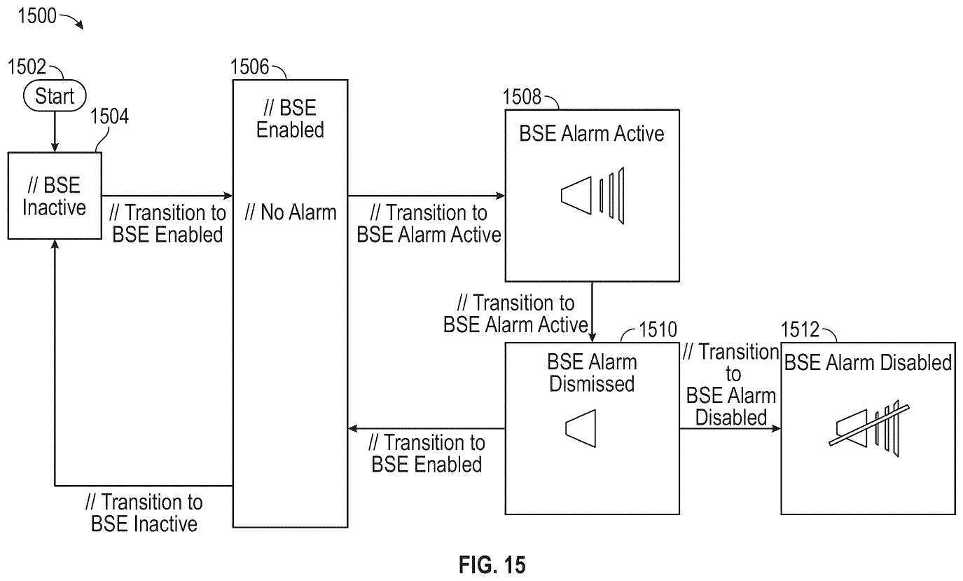

Referring to FIG. 15, a process 1500 illustrates different states that the controller 1302 or system 1300 may transition between, according to some embodiments. Process 1500 includes an inactive state 1504, an enabled state 1506, an alarm active state 1508, an alarm dismissed state 1510, and an alarm disabled state 1512, according to some embodiments. Process 1500 initiates at step 1502 (e.g., when the military vehicle 1000 is powered on).

Process 1500 may initially begin at the inactive state 1504. In some embodiments, the inactive state 1504 is a default or beginning state of the system 1300 or the controller 1302. The controller 1302 or the system 1300 may transition out of the inactive state 1504 and into the enabled state 1506 in response to the following conditions being true:
the current brake air supply pressure, p_{brake} is greater than a minimum of (i) a predetermined pressure value (e.g., 125 psi) or (ii) the minimum brake air supply pressure+15 (e.g., whichever of 125 psi or pₘᵢₙ+15 is less); or
the current brake air supply pressure, p_{brake}, is greater than the minimum brake air supply pressure+1 (e.g., p_{brake}>pₘᵢₙ+1) AND the minimum brake air supply pressure is ≥125 psi.

In some embodiments, the controller 1302 is configured to transition out of the inactive state 1504 and into the enable state 1506 if both (i) any of the above conditions are true, and (ii) the status of the system 1300 or the controller 1302 is currently the alarm active or the alarm active dismissed state. In this way, the controller 1302 may only transition into the enabled state from the alarm active or the alarm active dismissed state. It should be understood that the reference value 15 in the first condition shown above may be any other predetermined or incremental value.

In some embodiments, the controller 1302 or the system 1300 may transition out of the enabled state 1506 and back into the inactive state 1504 if the controller 1302 loses communication with any of the following for an amount of time greater than a predetermined amount (e.g., three seconds):
The DSDU 1312;
The signal associated with the primary air brake pressure, p_{primary}; or
The signal associated with the secondary air brake pressure, p_{secondary}.
   In some embodiments, the controller 1302 is configured to transition out of the current state into the inactive state if both (i) any of the above three conditions are true, and (ii) the system 1300 is not disabled by the user or operator.

In the enabled state 1506, the controller 1302 may continually monitor, obtain, or calculate the minimum brake air supply pressure pₘᵢₙ and the brake air supply pressure p_{brake} using any of the techniques described herein with reference to FIGS. 13-15. The controller 1302 may also compare the brake air supply pressure p_{brake} to the most recently obtained or determined minimum brake air supply pressure pₘᵢₙ to determine if an alarm should be provided (e.g., to determine if the controller 1302 and system 1300 should transition out of the enabled state 1506 and into the alarm active state 1508).

In some embodiments, the controller 1302 or the system 1300 is configured to transition out of the enabled state 1506 and into the alarm active state 1508 if any of the if the brake air supply pressure, p_{brake}, is less than the minimum brake air supply pressure pₘᵢₙ. When the controller 1302 and the system 1300 operate in the alarm active state 1508, the controller 1302 may operate the instrument panel 1310, the DSDU 1312, a display screen, an HMI, etc., to provide a visual and/or an aural alert to the operator of the military vehicle 1000.

In some embodiments, the controller 1302 is configured to transition out of the alarm active state 1508 and into the alarm dismissed state 1510 in response to an operator input that indicates the alarm should be dismissed or silenced. In some embodiments, the controller 1302 is configured to transition into the alarm dismissed state 1510 only when the controller 1302 is in the alarm active state 1508. In the alarm dismissed state 1510, the controller 1302 may operate the instrument panel 1310, the DSDU 1312, the display screen, the HMI, etc., to cease providing the aural and/or the visual alert. In some embodiments, the controller 1302 is also configured to operate the instrument panel 1310, the DSDU 1312, the display screen, the HMI, etc., to provide a visual and/or aural notification to notify the operator that the alarm has been dismissed. In some embodiments, the controller 1302 and the system 1300 are configured to transition out of the alarm active state 1508 and into the alarm dismissed state 1510 in response to the controller 1302 and the system 1300 being in the alarm active state 1508 for a predetermined amount of time.

In some embodiments, the controller 1302 and the system 1300 are configured to transition out of the alarm dismissed state 1510 and into the alarm disabled state 1512 in response to a user input that indicates that the alarm should be disabled. In some embodiments, the controller 1302 and the system 1300 are configured to transition out of the alarm dismissed state 1510 and into the alarm disabled state 1512 in response to the controller 1302 and the system 1300 being in the alarm dismissed state for a predetermined amount of timer. In the alarm disabled state 1512, the controller 1302 operates the instrument panel 1310, the DSDU 1312, the display screen, the HMI, etc., to cease providing the visual and the aural alert to the operator.

In some embodiments, the controller 1302 and the system 1300 are configured to transition out of the alarm dismissed state 1510 and back into the enabled state 1506 in response to the brake air supply pressure p_{brake} exceeding the minimum brake air supply pressure pₘᵢₙ, or in response to the brake air supply pressure p_{brake} exceeding the minimum brake air supply pressure pₘᵢₙ by a predetermined amount.

### Alarm Actuation Process

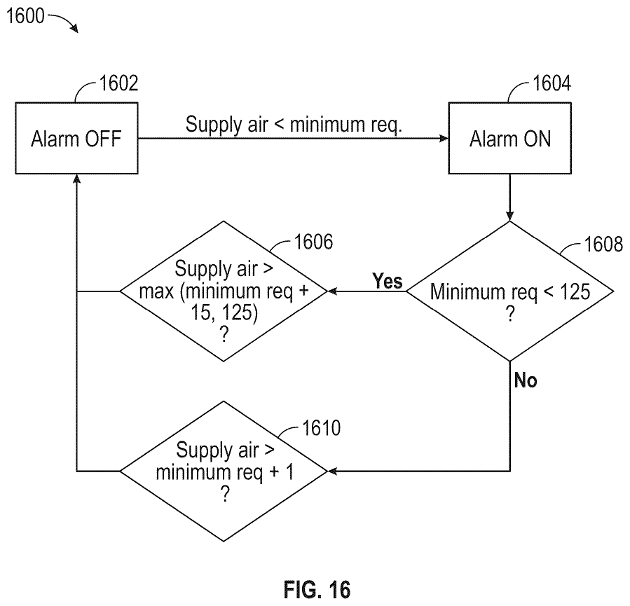

Referring to FIG. 16, a process 1600 for turning an alarm on or off for the military vehicle 1000 is shown, according to some embodiments. In some embodiments, process 1600 includes steps 1602-1610 and is performed by the controller 1302 or the system 1300.

Process 1600 starts with the alarm off (step 1602), according to some embodiments. When the brake air supply pressure p_{brake} is less than the minimum brake air supply pressure pₘᵢₙ, process 1600 proceeds to turning the alarm on (step 1604), and providing an alarm to the operator to notify the operator of the military vehicle 1000 that the current brake air supply pressure p_{brake} is too low. The controller 1302 can provide an alarm that may be a combination of an aural alarm and a visual alarm by operating the DSDU 1312. When the alarm is provided to the operator, process 1600 can include determining if the minimum brake air supply pressure pₘᵢₙ is less than a predetermined value such as 125 psi (step 1608). If the minimum brake air supply pressure pₘᵢₙ is less than the predetermined value (step 1608, “YES”), process 1600 proceeds to step 1606. If the minimum brake air supply pressure pₘᵢₙ is greater than the predetermined value (step 1608, “NO”), process 1600 proceeds to step 1610.

Process 1600 includes determining if the brake air supply pressure p_{brake} is greater than a maximum of (i) the minimum brake air supply pressure pₘᵢₙ plus an incremental amount such as 15 psi, and (ii) the predetermined value from step 1608 (step 1606), according to some embodiments. If the brake air supply pressure p_{brake} is greater than the maximum of (i) the minimum brake air supply pressure pₘᵢₙ plus an incremental amount such as 15 psi, and (ii) the predetermined value from step 1608, process 1600 returns to step 1602, and the alarm is shut off, since the brake air supply pressure p_{brake} is now sufficiently high. If the brake air supply pressure p_{brake} is not greater than the maximum of (i) the minimum brake air supply pressure pₘᵢₙ plus an incremental amount such as 15 psi, and (ii) the predetermined value from step 1608, process 1600 persists in step 1604 with the alarm on.

Process 1600 includes determining if the brake air supply pressure p_{brake} is greater than: the minimum brake air supply pressure pₘᵢₙ plus an incremental amount (e.g., 1 psi) (step 1610), according to some embodiments. If the brake air supply pressure p_{brake} is greater than pₘᵢₙ+1, process 1600 returns to step 1602 and the alarm is shut off. If the brake air supply pressure p_{brake} is less than pₘᵢₙ+1, process 1600 persists in step 1604 and the alarm is provided. If process 1600 returns to step 1602 from step 1604 (e.g., after the brake air supply pressure p_{brake} has reached a sufficient or acceptable level), the controller 1302 can operate the DSDU 1312 to cease providing the aural alarm, or may change a color of the visual alarm (e.g., change the color from red to yellow). In some embodiments, if the brake air supply pressure p_{brake} is greater than the minimum brake air supply pressure pₘᵢₙ, the controller 1302 may silence a previously provided audible alarm. In some embodiments, providing the aural alarm does not interfere with operation of a federal motor vehicle safety standards (FMVSS) alarm.

### Alarm Dismiss and Disable Process

Referring to FIG. 17, a diagram 1700 of a process for dismissing an alarm through operation of the DSDU 1704 is shown, according to some embodiments. The diagram 1700 illustrates a 3G controller 1702 that communicates with the DSDU 1704. The 3G controller 1702 may be a lower level controller that communicates with the controller 1302. In some embodiments, the controller 1302 includes the 3G controller 1702. In some embodiments, the 3G controller 1702 is operated by the controller 1302 and performs operations provided by the controller 1302. The 3G controller 1702 can include processing circuitry for performing any of the functions described herein. The DSDU 1704 may be the DSDU 1312.

The 3G controller 1702 can be configured to provide text alerts (e.g., shown as “BSE Amber_Text”) to the DSDU 1704 for display on the DSDU 1704. In some embodiments, the 3G controller 1702 is also configured to provide a current status of the system 1300 (shown as “BSE_System_Status”) to the DSDU 1704. The 3G controller 1702 may receive a dismiss command (shown as “BSE_Dismiss”) from the DSDU 1704, and a disable command (shown as “BSE_Disable”) from the DSDU 1704.

At steps 1710 and 1712, the DSDU 1704 operates to display a dismiss button or key if the current status or state of the system is the alarm active state. If the dismiss button is pressed (step 1714), then the DSDU 1704 displays a disable button or key (step 1716), and provides an indication to the 3G controller 1702 that the alarm should be dismissed (shown as “BSE_Dismiss”). If the disable button is pressed (step 1718), and the user confirms this selection (step 1720), then the DSDU 1704 provides a command (shown as “BSE_Disable”) to the 3G controller 1702 to disable alarm functionality (step 1722).

Referring to FIG. 18, another process 1800 for dismissing or disabling alarms of the system 1300 is shown, according to some embodiments. Process 1800 includes steps 1802-1814 and can be performed by the controller 1302. When process 1800 begins at step 1802, there is no alarm, and dismiss and disable parameters, shown as BSE_Dismiss and BSE_Disable are set to 0.

If the status of the system 1300 transitions into an alarm active state (e.g., an alarm is actively provided to the operator, shown as “BSE_System_Status==1”, process 1800 proceeds to step 1804. At step 1804, the DSDU 1312 and/or the instrument panel 1310 are operated by the controller 1302 to provide the alarm to the operator, and to provide a selection or button for the operator to dismiss the alarm. If the operator presses the button to dismiss the alarm, process 1800 proceeds to step 1806. If the alarm stops due to conditions changing, the system 1300 transitions out of the alarm state and returns to step 1802.

If the operator presses the dismiss button, then process 1800 proceeds to step 1806, where a dismiss parameter (shown as “BSE_Dismiss”) is set to indicate that the dismiss button has been pressed (shown as “Latch BSE_Dismiss=1”). If the alarm condition has ceased, process 1800 returns from step 1806 to step 1802. If the alarm condition has not ceased, process 1800 proceeds from step 1806 to step 1808.

At step 1808, the DSDU 1312 operates to display a disable button, according to some embodiments. If the alarm condition ceases, process 1800 returns from step 1808 to step 1802. If the user or operator presses the disable button to disable the alarm, process 1800 proceeds to step 1810. At step 1810 the DSDU 1312 presents a confirmation screen to the operator to prompt the operator to confirm the disable command indicated in step 1808. If confirmation is not input by the operator (e.g., the operator selects a cancel button) or if a timeout occurs (e.g., the DSDU 1312 does not receive an input from the operator for a certain amount of time), process 1800 may return from step 1810 to step 1808 without disabling the system 1300. If the user confirms that the system 1300 should be disabled at step 1810 (e.g., by selecting a confirmation button), process 1800 sets the status of the system 1300 to disabled and maintains the system 1300 disabled until power is cycled (steps 1812 and 1814). In response to disabling the system 1300, process 1800 returns to step 1802.

### Graphical User Interfaces

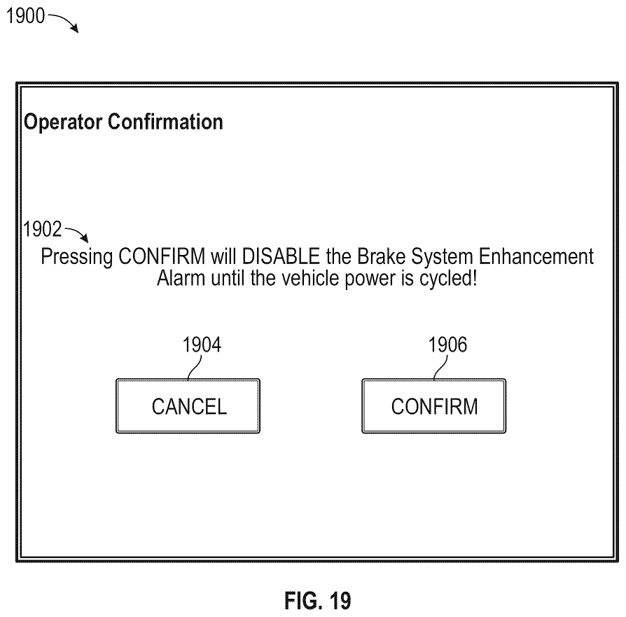

Referring to FIG. 19, a graphical user interface (GUI) 1900 illustrates a confirmation screen that can be displayed to the operator via the DSDU 1312 at step 1810 of process 1800. GUI 1900 may be presented to the operator on the DSDU 1312 or display screen thereof when the operator has selected or requested to disable the system 1300. The GUI 1900 includes a message 1902 that notifies the operator that pressing a confirm button 1906 will disable the brake system enhancement alarm until power is cycled. If the operator presses the confirm button 1906, the system 1300 and controller 1302 are transitioned into the alarm disabled state. If the operator presses a cancel button 1904, the system 1300 and controller 1302 are not transitioned into the alarm disabled state.

Referring to FIG. 20, another GUI 2000 that can be presented on the DSDU 1312 is shown, according to some embodiments. The GUI 2000 includes a speed display 2002 that indicates a current speed of the military vehicle 1000, and a tachometer display 2004 that indicates current revolutions per minute (rpm) of the military vehicle 1000. The GUI 2000 may also include a list 2010 of various information including a current gear, a current fuel percentage, engine oil pressure, rear air pressure, front air pressure, air restriction, battery voltage, engine coolant temperature, transmission oil temperature, central tire inflation system (CTIS) terrain setting, a suspension automatic leveling status, etc. The GUI 2000 also includes a brake alarm 2006 that is configured to light up or activate when the controller 1302 is in the alarm active state, or when the brake air supply pressure p_{brake} is less than the minimum brake air supply pressure pₘᵢₙ. The GUI 2000 also includes a brake disable alarm 2008 that may be actuated when the operator disables the system 1300 from operating to provide alerts regarding low air brake supply pressure. The GUI 2000 also includes various other selectable icons 2012 so that the operator can press the icons 2012 (e.g., buttons) to navigate between different screens on the DSDU 1312.

### Surface Incline/Grade

Referring to FIGS. 21A-21B, a diagram 2100 and a diagram 2150 illustrate positive and negative slopes or grades. Diagram 2100 illustrates a positive grade or incline, when the vehicle 1000 is travelling uphill or on a surface that is angled upwards. An angle 2102 (shown as +θ) illustrates a positive or upwards grade or incline, as shown in FIG. 21A. An angle 21B (shown as −θ) illustrates a negative or downwards grade or incline, shown in FIG. 21B. The angle 2102 or the angle 2104 (e.g., a value of the angle θ and a direction of the angle θ) can be measured by the suspension system 460 of the military vehicle 1000.

### Overall Process

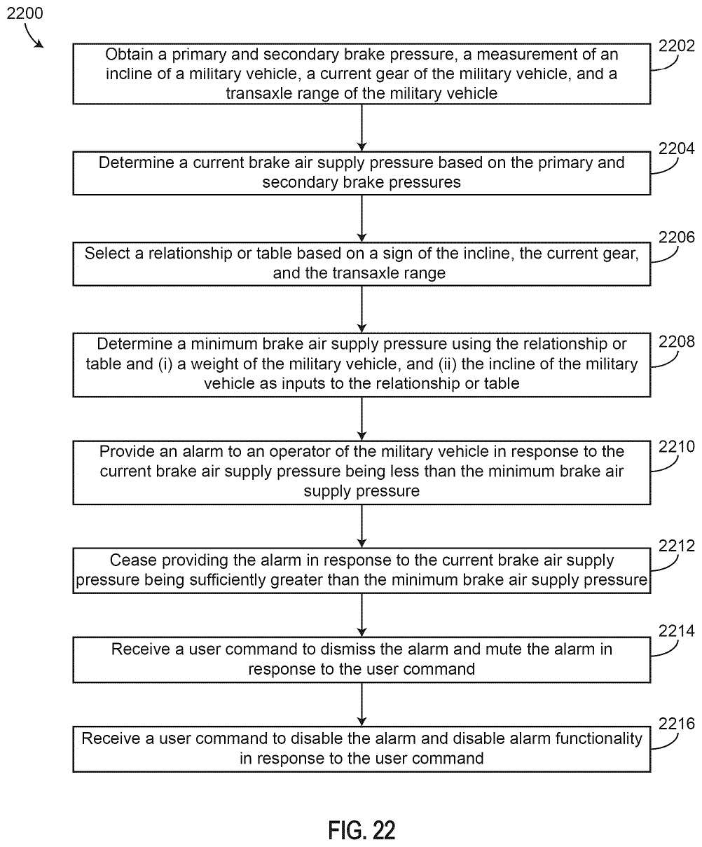

Referring to FIG. 22, a flow diagram of a process 2200 for providing brake air supply pressure alarms or alerts is shown. The process 2200 illustrates the functionality of the BSES 1300, or any of the processes illustrated in FIGS. 14-18 from a higher level. The process 2200 includes steps 2202-2216 and can be performed by the BSES 1300.

The process 2200 includes obtaining a primary and secondary brake pressure of a military vehicle, a measurement of an incline of the military vehicle, a current gear of the military vehicle, and a transaxle range of the military vehicle (step 2202), according to some embodiments. The military vehicle may be the military vehicle 1000. The primary and secondary brake pressures can be obtained from the instrument panel 1310, or the brake system 700. The measurement of the incline of the military vehicle (e.g., 0) can be obtained from the suspension system 460. The current gear of the military vehicle can be obtained from the transmission 400. The transaxle range can be obtained from the transaxle 450 of the military vehicle. Step 2202 can also include obtaining a weight w of the military vehicle (e.g., from the suspension system 460). In some embodiments, step 2202 is performed by the controller 1302, or the processing circuitry 1304.

The process 2200 also includes determining a current brake air supply pressure based on the primary and secondary brake pressures (step 2204), according to some embodiments. In some embodiments, the current brake air supply pressure is obtained from the instrument panel 1310 or the brake system 700. In some embodiments, the current brake air supply pressure is an average of the primary and secondary brake pressures. In some embodiments, the current brake air supply pressure is a weighted average of the primary and secondary brake pressures. In some embodiments, step 2204 is performed by the controller 1302 or the processing circuitry 1304.

The process 2200 also includes selecting a relationship or table based on a sign of the incline, the current gear, and the transaxle range (step 2206), according to some embodiments. In some embodiments, the sign of the incline may be positive or negative, the current gear may be considered a “forwards” or a “reverse” gear, and the transaxle range may be “high” or “low.” In some embodiments, step 2206 can include selecting from eight different relationships or tables (e.g., Tables 1-8 as discussed above). In some embodiments, step 2206 is performed by the controller 1302 or processing circuitry 1304.

The process 2200 includes determining a minimum brake air supply pressure using the relationship or table and (i) a weight of the military vehicle, and (ii) the incline of the military vehicle as inputs to the relationship or table (step 2208), according to some embodiments. In some embodiments, the weight of the military vehicle and the incline (e.g., an absolute value of the military vehicle) are used as inputs to the relationship or table in order to determine the value of the minimum brake air supply pressure. The minimum brake air supply pressure that is determined or selected can be obtained such that the military vehicle has sufficient braking capabilities to come to a complete stop, given the weight and incline of the military vehicle for the corresponding incline (e.g., positive or negative), current gear, and transaxle range. In some embodiments, step 2208 includes interpolating or extrapolating to determine the value of the minimum brake air supply pressure. Step 2208 can be performed by the controller 1302 or the processing circuitry 1304.

The process 2200 includes providing an alarm to an operator of the military vehicle in response to the current brake air supply pressure being less than the minimum brake air supply pressure (step 2210), according to some embodiments. If the current brake air supply pressure is less than the minimum brake air supply pressure, this may indicate that the current brake air supply pressure is insufficient to fully stop the military vehicle given current conditions. If the current brake air supply pressure is less than the minimum brake air supply pressure, the controller 1302 may operate the DSDU 1312, or the instrument panel 1310 to provide a visual and audible alert to the operator to notify the operator that the current brake air supply pressure is too low. The operator may then wait until the current brake air supply pressure has built up to a sufficient level (e.g., sufficiently greater than the minimum brake air supply pressure) before operating the military vehicle.

The process 2200 includes ceasing to provide the alarm in response to the current brake air supply pressure being sufficiently greater than the minimum brake air supply pressure (step 2212), according to some embodiments. In some embodiments, if the current brake air supply pressure exceeds the minimum brake air supply pressure by a predetermined or threshold amount, the alarm is cleared, since the current brake air supply pressure is now sufficient. In some embodiments, performing steps 2210-2212 includes performing process 1600 as described in greater detail above with reference to FIG. 16. In some embodiments, step 2212 is performed by the controller 1302 or the processing circuitry 1304.

The process 2200 includes receiving a user command to dismiss the alarm and muting the alarm in response to the user command (step 2214) and also receiving a user command to disable the alarm and disabling alarm functionality in response to the user command (step 2216), according to some embodiments. In some embodiments, steps 2214 and 2216 are performed by the controller 1302 or the processing circuitry 1304. In some embodiments, performing steps 2214 and 2216 includes performing any of the functionality or processes described in greater detail above with reference to FIGS. 17-18. In some embodiments, if the controller 1302 receives a command to dismiss the alarm, the controller 1302 mutes the alarm and transitions a color of the visual alert from red (as presented in step 2210) to yellow. In some embodiments, if the controller receives a command to disable the alarm, the controller 1302 shuts off both visual and audible alarms or alerts, and limits or restricts further alarms until power of the military vehicle is cycled.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A control system for a military vehicle, the control system comprising processing circuitry configured to:
obtain a weight, an incline, a brake air supply pressure, a current gear, and a transaxle range of the military vehicle during transportation of the military vehicle;
determine a minimum brake air supply pressure for the military vehicle based on the weight, the incline, the current gear, and the transaxle range of the military vehicle;
compare the brake air supply pressure to the minimum brake air supply pressure; and
in response to the brake air supply pressure being less than the minimum brake air supply pressure:
operate a display of the military vehicle to provide an alarm to an operator of the military vehicle to notify the operator that the brake air supply pressure is less than the minimum brake air supply pressure until either the brake air supply pressure increases above the minimum brake air supply pressure or a user command to disable the alarm is obtained via the display.

2. The control system of claim 1, wherein determining the minimum brake air supply pressure comprises:
selecting a relationship or a table from a plurality of relationships or tables based on (i) a sign of the incline, (ii) whether the current gear is a forwards or a reverse gear, and (iii) whether the transaxle range is high or low;
using (i) an absolute value of the incline and (ii) the weight of the military vehicle as inputs to the relationship or table to determine the minimum brake air supply pressure.

3. The control system of claim 2, wherein the plurality of relationships or tables comprise eight relationships or tables, each of the eight relationships or tables corresponding to a particular combination of (i) the sign of the incline, (ii) whether the current gear is a forwards or a reverse gear, and (iii) whether the transaxle range is high or low.

4. The control system of claim 1, wherein the minimum brake air supply pressure is a trigger value to prompt the alarm to notify the operator that the military vehicle should be brought to a complete stop to allow a brake system of the military vehicle to re-pressurize.

5. The control system of claim 1, wherein the processing circuitry is configured to operate the display of the military vehicle to cease providing the alarm in response to the brake air supply pressure exceeding the minimum brake air supply pressure by at least a predetermined amount.

6. The control system of claim 1, wherein obtaining the brake air supply pressure comprises:
obtaining a primary brake air pressure and a secondary brake air pressure; and
determining an average of the primary brake air pressure and the secondary brake air pressure as the brake air supply pressure.

7. The control system of claim 1, wherein the processing circuitry is configured to:
receive a user command to dismiss the alarm; and
mute an aural alert of the alarm in response to receiving the user command to dismiss the alarm.

8. The control system of claim 7, wherein the processing circuitry is further configured to:
present a confirmation screen to the operator in response to receiving the user command to disable the alarm; and
in response to receiving a confirmation from the operator to disable the alarm, disabling the alarm and limiting further alarm functionality until power of the military vehicle is cycled.

9. The control system of claim 1, wherein the processing circuitry is configured to obtain the weight of the military vehicle from a suspension system of the military vehicle, the incline from the suspension system of the military vehicle, the brake air supply pressure from an instrument panel of the military vehicle, the current gear from a transmission of the military vehicle, and the transaxle range from a transaxle of the military vehicle.

10. The control system of claim 1, wherein the control system is operable between:
an enabled state in which the processing circuitry continually determines the minimum brake air supply pressure, and compares the brake air supply pressure to the minimum brake air supply pressure, and does not provide the alarm to the operator;
an alarm active state in which the processing circuitry operates the display of the military vehicle to provide the alarm comprising an aural alert;
an alarm dismissed state in which the processing circuitry mutes the aural alert of the alarm; and
an alarm disabled state in which the processing circuitry does not provide the alarm, restricts additional alarm functionality of the control system, and provides a visual alert that the control system is in the alarm disabled state.

11. The control system of claim 10, wherein the processing circuitry is configured to:
initially transition the control system into the enabled state in response to obtaining the weight, the incline, the brake air supply pressure, the current gear, and the transaxle range, and determining the minimum brake air supply pressure;
transition the control system out of the enabled state and into the alarm active state in response to the brake air supply pressure being less than the minimum brake air supply pressure;
transition the control system out of the alarm active state and into the alarm dismissed state in response to receiving a command from the operator to dismiss the alarm;
transition the control system out of the alarm dismissed state and into the alarm disabled state in response to receiving a command from the operator to disable the alarm, and in response to confirmation from the operator to transition into the alarm disabled state; and
transition the control system out of the alarm dismissed state or the alarm active state and into the enabled state in response to the brake air supply pressure exceeding the minimum brake air supply pressure by a predetermined amount.

12. A control system for a military vehicle, the control system comprising processing circuitry configured to:
obtain a weight, an incline, a brake air supply pressure, a current gear, and a transaxle range of the military vehicle;
determine a minimum brake air supply pressure for the military vehicle based on the weight, the incline, the current gear, and the transaxle range of the military vehicle during transportation of the military vehicle;
compare the brake air supply pressure to the minimum brake air supply pressure; and
in response to the brake air supply pressure being less than the minimum brake air supply pressure:
operate a display of the military vehicle to provide an alarm to an operator of the military vehicle to notify the operator that the brake air supply pressure is less than the minimum brake air supply pressure until either the brake air supply pressure increases above the minimum brake air supply pressure or a user input to clear the alarm is obtained via the display;
wherein the control system is operable between:
an enabled state in which the processing circuitry continually determines the minimum brake air supply pressure, and compares the brake air supply pressure to the minimum brake air supply pressure, and does not provide the alarm to the operator;
an alarm active state in which the processing circuitry operates the display of the military vehicle to provide the alarm comprising an aural alert;
an alarm dismissed state in which the processing circuitry mutes the aural alert of the alarm; and
an alarm disabled state in which the processing circuitry does not provide the alarm, restricts additional alarm functionality of the control system, and provides a visual alert that the control system is in the alarm disabled state.

13. The control system of claim 12, wherein the processing circuitry is configured to:
initially transition the control system into the enabled state in response to obtaining the weight, the incline, the brake air supply pressure, the current gear, and the transaxle range, and determining the minimum brake air supply pressure;
transition the control system out of the enabled state and into the alarm active state in response to the brake air supply pressure being less than the minimum brake air supply pressure;
transition the control system out of the alarm active state and into the alarm dismissed state in response to receiving a command from the operator to dismiss the alarm;
transition the control system out of the alarm dismissed state and into the alarm disabled state in response to receiving a command from the operator to disable the alarm, and in response to confirmation from the operator to transition into the alarm disabled state; and
transition the control system out of the alarm dismissed state or the alarm active state and into the enabled state in response to the brake air supply pressure exceeding the minimum brake air supply pressure by a predetermined amount.

14. The control system of claim 12, wherein determining the minimum brake air supply pressure comprises:
selecting a relationship or a table from a plurality of relationships or tables based on (i) a sign of the incline, (ii) whether the current gear is a forwards or a reverse gear, and (iii) whether the transaxle range is high or low;
using (i) an absolute value of the incline and (ii) the weight of the military vehicle as inputs to the relationship or table to determine the minimum brake air supply pressure.

15. The control system of claim 14, wherein the plurality of relationships or tables comprise eight relationships or tables, each of the eight relationships or tables corresponding to a particular combination of (i) the sign of the incline, (ii) whether the current gear is a forwards or a reverse gear, and (iii) whether the transaxle range is high or low.

16. The control system of claim 12, wherein the minimum brake air supply pressure is a trigger value to prompt the alarm to notify the operator that the military vehicle should be brought to a complete stop to allow a brake system of the military vehicle to re-pressurize.

17. The control system of claim 12, wherein obtaining the brake air supply pressure comprises:
obtaining a primary brake air supply pressure and a secondary brake air supply pressure; and
determining an average of the primary brake air supply pressure and the secondary brake air supply pressure as the brake air supply pressure.

18. The control system of claim 12, wherein the processing circuitry is configured to obtain the weight of the military vehicle from a suspension system of the military vehicle, the incline from the suspension system of the military vehicle, the brake air supply pressure from an instrument panel of the military vehicle, the current gear from a transmission of the military vehicle, and the transaxle range from a transaxle of the military vehicle.

19. A control system for a military vehicle, the control system comprising processing circuitry configured to:
obtain a weight, an incline, a brake air supply pressure, a current gear, and a transaxle range of the military vehicle during transportation of the military vehicle;
determine a minimum brake air supply pressure for the military vehicle based on the weight, the incline, the current gear, and the transaxle range of the military vehicle;
compare the brake air supply pressure to the minimum brake air supply pressure; and
in response to the brake air supply pressure being less than the minimum brake air supply pressure:
operate a display of the military vehicle to provide an alarm to an operator of the military vehicle to notify the operator that the brake air supply pressure is less than the minimum brake air supply pressure until either the brake air supply pressure increases above the minimum brake air supply pressure or a user input to clear the alarm is obtained via the display;
wherein determining the minimum brake air supply pressure comprises:
selecting a relationship or a table from a plurality of relationships or tables based on (i) a sign of the incline, (ii) whether the current gear is a forwards or a reverse gear, and (iii) whether the transaxle range is high or low;
using (i) an absolute value of the incline and (ii) the weight of the military vehicle as inputs to the relationship or table to determine the minimum brake air supply pressure.

20. The control system of claim 19, wherein the plurality of relationships or tables comprise eight relationships or tables, each of the eight relationships or tables corresponding to a particular combination of (i) the sign of the incline, (ii) whether the current gear is a forwards or a reverse gear, and (iii) whether the transaxle range is high or low.
